(19) United States
(12) Patent Application Publication
(10) Pub. No.: US 2026/0149598 A1
(43) Pub. Date: May 28, 2026

(54) METHODS, DEVICES AND SYSTEMS FOR SECURE ACCESS TO WIRELESS DEVICE INFORMATION WITH SINGLE TRANSACTION OR LIMITED NUMBER OF TRANSACTIONS

(71) Applicant: Cypress Semiconductor Corporation, San Jose, CA (US)

(72) Inventors: Hui Luo, Marlboro, NJ (US); Rakesh Taori, McKinney, TX (US)

(73) Assignee: Cypress Semiconductor Corporation, San Jose, CA (US)

(21) Appl. No.: 19/226,492

(22) Filed: Jun. 3, 2025

Related U.S. Application Data
(60) Provisional application No. 63/725,143, filed on Nov. 26, 2024.

(51) Int. Cl. H04L 9/32; H04L 9/08

(52) U.S. Cl. CPC H04L 9/3242; H04L 9/0869

(57) ABSTRACT

Embodiments can include, by operation of an ambient wireless device, wirelessly receiving a wakeup data frame having a broadcast-type address, a first random number (R1) and a received hash value. Using ambient energy, a hashing operation can be executed using at least a previously stored first device ID and R1 to generate a local hash value to validate the wakeup frame. In response to a validated wakeup frame, an address (Aa), second random value (R2), and an encryption key can be generated, the latter using at least a previously stored secret value (P). Using ambient energy, UL data can be encrypted using the encryption key. A response data frame can be transmitted that includes Aa as a source address, R1, R2, and the encrypted UL data. The ambient energy can be derived from radio frequency signals present in an operating environment. Corresponding devices and systems are also disclosed.

### CROSS-REFERENCE TO RELATED APPLICATIONS

The present application claims the priority and benefit of U.S. Patent Application Number Ser. No. 63/725,143 filed on Nov. 26, 2024, the contents of which are incorporated by reference herein in their entirety.

### TECHNICAL FIELD

The present disclosure relates generally to wireless systems, and more particularly systems to wireless systems in which one device operates on very limited power, including wireless devices that operate on ambient power present in, or harvested from, the operating environment.

### BACKGROUND

Ambient devices can operate on limited power from radio-frequency (RF) energy signals present in an operating environment. In operation, ambient devices can accumulate very limited power from RF excitation signals during a harvesting cycle. Some ambient devices can operate with single data frame exchanges during a charging cycle, receiving downlink data in a data frame, and in response, sending uplink data in a transmitted data frame. In some cases, an ambient device may only be capable of responding with a single backscatter data frame (e.g., redirecting received RF energy into a reflected uplink data frame).

Due to the limited power that can be harvested from ambient RF sources, ambient devices may not be capable of storing session data for a long period of time in memory (both non-volatile and volatile memory). This can make it difficult to establish secure communications, for example, communications that can prevent replay attacks.

Conventional approaches for ambient device communications are known. Such approaches can utilize two data frame exchanges to establish mutual authentication, establish an encryption key, and encrypt uplink data (i.e., data transmitted from an ambient device). A drawback to such a conventional method can be the need to maintain session data between the two data frame exchange operations. In the event a transaction involves access to a server, session data may have to be stored for a relatively long time, which may require more ambient energy than is available to or accumulated by an ambient device. In addition, in some cases an ambient device's design may result in it having sufficient energy for only a single data frame exchange.

It would be desirable to arrive at some way of providing for a secure exchange of data with an ambient device that can occur with a low number of data frame exchanges, preferably as little as one exchange.

### SUMMARY

A method can include, by operation of an ambient wireless device, wirelessly receiving a wakeup data frame having a broadcast-type address, a first random number (R1) and a received hash value. Using ambient energy, a hashing operation can be executed using a previously stored first device ID and R1 to generate a local hash value to validate the wakeup frame. In response to a validated wakeup frame, an address (Aa) and second random value (R2) can be generated. In addition, an encryption key can be generated using at least a previously stored secret value (P). Using ambient energy, UL data can be encrypted using the encryption key. A response data frame can be transmitted that includes Aa as a source address, R1, R2, and the encrypted UL data. The ambient energy can be derived from radio frequency signals present in an operating environment. Corresponding devices and systems are also disclosed.

### BRIEF DESCRIPTION OF DRAWINGS

FIG. 1 is a diagram showing a system and operations according to an embodiment.

FIG. 2 is a diagram showing a system and operations according to another embodiment.

FIG. 3 is a diagram showing a system and operations according to a further embodiment.

FIG. 4 is a signaling diagram showing a system and operations according to an embodiment.

FIG. 5 is a signaling diagram showing a system and operations according to another embodiment.

FIGS. 6-0 and 6-1 show a signaling diagram of a system and operations according to a further embodiment.

FIGS. 7-0 and 7-1 show a signaling diagram of a system and operations according to another embodiment.

FIGS. 8-0 and 8-1 show a signaling diagram of a system and operations according to a further embodiment.

FIGS. 9-0 and 9-1 show a signaling diagram of a system and operations according to another embodiment.

FIGS. 10-0, 10-1 and 10-2 show a signaling diagram of a system and operations according to a further embodiment.

FIGS. 11-0, 11-1 and 11-2 show a signaling diagram of a system and operations according to another embodiment.

FIG. 12 is a block diagram of an ambient device according to an embodiment.

FIG. 13 is a block diagram of an ambient device according to another embodiment.

FIG. 14 is a diagram of an integrated circuit device according to a further embodiment.

FIG. 15 is a diagram of an ambient device according to a further embodiment.

FIG. 16 is a block diagram of an ambient device according to an embodiment.

FIG. 17 is a block diagram of a reader device according to an embodiment.

FIG. 18 is a block diagram of a server system according to an embodiment.

FIG. 19 is a flow diagram of a method executable by an ambient device according to an embodiment.

FIGS. 20-0 and 20-1 show a flow diagram of a method executable by an ambient device according to another embodiment.

FIG. 21 is a diagram of a system according to an embodiment.

### DETAILED DESCRIPTION

According to embodiments, a secure transaction method for wireless communications can complete encryption key generation, encryption of uplink (UL) data, and authentication of UL data in a single data frame exchange. A single data frame exchange can include a downlink (DL) (e.g., wakeup) data frame transmitted by a reader device (reader) and received by an ambient device, and an UL (e.g., response) data frame transmitted by the ambient device and received by the reader.

In some embodiments, a UL data frame can be backscatter data frame. A backscatter data frame can be a data frame transmitted by redirecting received ambient radio frequency (RF) energy.

In some embodiments, a secure transaction can be based on a secret value shared between a reader and an ambient device. In some embodiments, such a secret value can be a high entropy secret value.

In some embodiments, a secure, single data frame exchange can include an ambient device executing one hashing operation and one encryption operation. In some embodiments, an encryption operation can be a symmetric encryption operation using an encryption independently derived by a reader. In some embodiments, an encryption operation can be a lightweight cryptography scheme that can provide secure encryption while consuming relatively little power. In some embodiments, an encryption can utilize an encryption method selected from the ASCON family.

In some embodiments, a secure transaction can include a reader requesting permission from a server to read from an ambient device. A server can receive data read by a reader, decrypt such data, and return decrypted data to the reader.

In some embodiments, an ambient device can be capable of servicing more than one transaction with a reader device, including a two-step authentication operation.

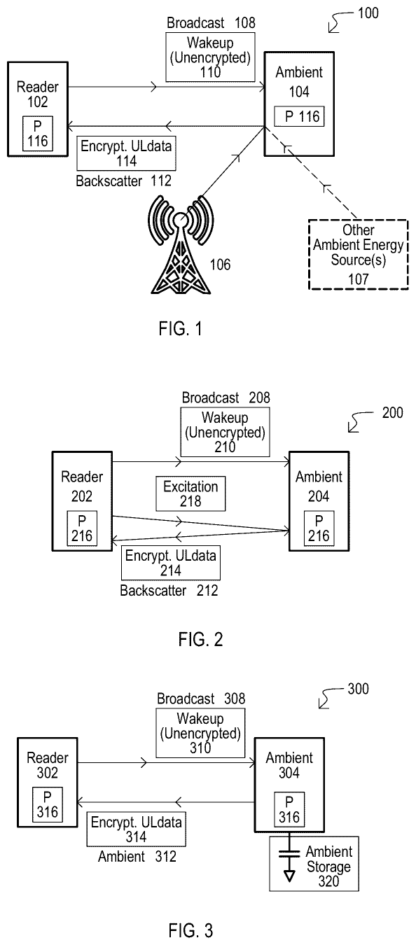

FIG. 1 is a diagram of a system 100 according to an embodiment. A system 100 can include a reader device 102, an ambient device 104 and an ambient energy source 106. A reader device 102 and ambient device 104 can share a secret value (P) 116. A reader device 102 can broadcast a wakeup message 108. A wakeup message can have an address, or other indication, that can be recognized by target ambient devices. That is, it is not targeted to one particular ambient device. In some embodiments, wakeup 108 message can indicate a desired response (e.g., the return of read data). A wakeup message 108 can be unencrypted 110.

An ambient device 104 can operate on RF energy available in its environment. In response to wakeup message 108, ambient device 104 can generate (or access) uplink (UL) data, encrypt such UL data, and transmit encrypted UL data 114 in a response message 112. UL data can be encrypted using an encryption key generated with the use of secret value P 116.

An ambient energy source 106 can transmit RF energy that can be used by ambient device 104 to generate response message 112. In some embodiments, response message 112 can be a backscatter data frame transmitted by reflecting and modulating RF signal(s) in the environment. In the embodiment of FIG. 1, such RF signal(s) are not generated by the reader 112. That is, a source of ambient RF energy 106 is not the reader 102. In some embodiments, a backscatter message 112 can be generated by modulating the impedance of an antenna system. In addition or alternatively, ambient device 104 can use ambient energy from some other source 107 in the environment that provides or harvests ambient energy. Other sources of ambient energy 107 can include, but are by means limited to, thermal energy (including temperature gradients/differentials), mechanical energy, magnetic fields (including movements therethrough), and/or light (both natural and artificial).

Upon receiving backscatter message 112, reader 102 can generate the same encryption key using secret value 106. Encrypted UL data 114 can be decrypted using such an encryption key.

In some embodiments, the transaction shown in FIG. 1 can include one transaction that includes the transmission of a wakeup message and the return of a response message.

In this way, in response to a broadcast wakeup message from a reader device, an ambient device, using ambient RF energy, can encrypt UL data and transmit a response message that includes the encrypted UL data.

FIG. 2 is a block diagram of another system 200 according to an embodiment. System 200 can include items like those of FIG. 1, and such like items are referred to by the same reference character but with the leading digit being a “2” instead of “1”.

System 200 can differ from that of FIG. 1 in that a reader device 202 can transmit an excitation energy 218, from which ambient device 204 can generate and transmit a response message 212. In some embodiments, excitation energy 218 can also be used by ambient device 204 to generate the encryption key and execute the encryption of UL data 214.

In this way, in response to a broadcast wakeup message from a reader device, and using excitation RF energy transmitted by the reader device, an ambient device can encrypt UL data and transmit a response message that includes the encrypted UL data.

FIG. 3 is a block diagram of another system 300 according to another embodiment. System 300 can include items like those of FIG. 1, and such like items are referred to by the same reference character but with the leading digit being a “3” instead of “1”.

System 300 can differ from that of FIG. 1 in that it can include ambient storage 320. An ambient device 304 can store RF energy from an environment in ambient storage 320. Energy stored by ambient storage 320 can be used for any of, generating an encryption key using shared secret 316, encrypting UL data with the encryption key, and/or transmitting response message 320.

In this way, in response to a broadcast wakeup message from a reader device, using at least some stored RF energy, an ambient device can encrypt UL data and transmit a response message that includes the encrypted UL data.

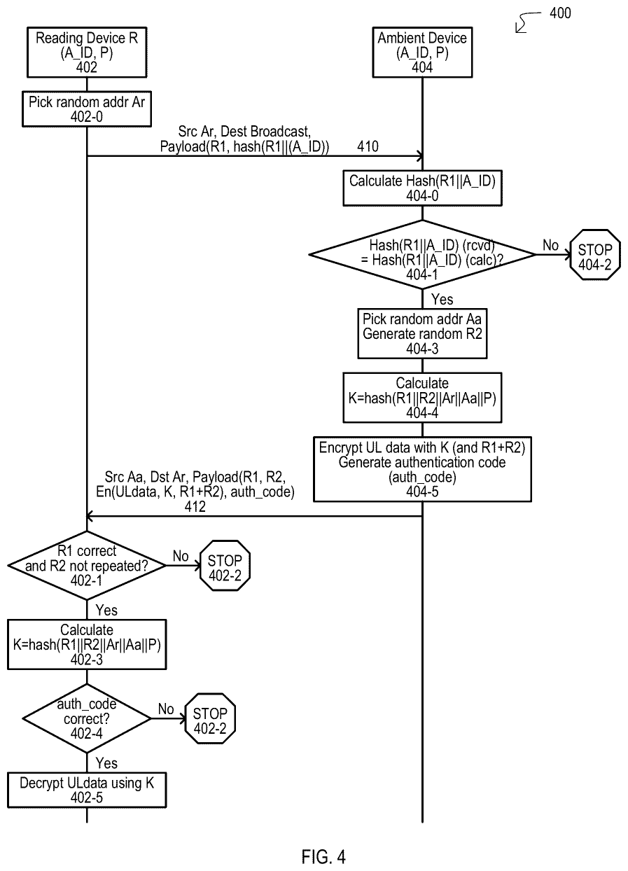

FIG. 4 is a signaling diagram showing a system 400 and operations according to an embodiment. A system 400 can include a reading device 402 and an ambient device 404. Reader device and ambient device (402, 404) can both store a device ID (A_ID) that can identify ambient device 404, as well as a shared secret P. In some embodiments, a shared secret P can have high entropy.

Operations of a system 400 can include a reader picking or using an address (Ar) 402-0. In some embodiments, such an action can include generating a random MAC address that can serve as a source address for reader 402. A reader 402 may also generate a random number (R1) and then execute a hashing algorithm using R1 and A_ID. In some embodiments, R1 and A_ID can be concatenated. In some embodiments, such a hashing operation can be a cryptographic hashing operation that uses P as a key.

Reader 402 can then transmit a wakeup/excitation (wakeup) data frame (frame) 410. Wakeup frame 410 can include Ar as a source address (Src Ar) and a broadcast address as a destination address (Dest Broadcast). A broadcast address can be a value established according to a standard/protocol that is interpreted by receiving devices as a valid destination address in addition to their device destination address. In some embodiments a broadcast address can be a multi-cast address. A payload data of wakeup frame 410 can include R1 and the hash result (hash(A_ID∥R1)). It is noted that wakeup frame 410 can be unencrypted.

Ambient device 404 can receive wakeup frame 410, and because it has a broadcast destination address, can process the wakeup frame 410. Ambient device 404 can execute a same hashing operation on R1 received in wakeup frame 410, and its own stored A_ID value. In some embodiments, ambient device 404 can be configured to execute the same hashing operation as that used by reader 402. However, in alternate embodiments, ambient device 410 can select from one or multiple hashing operations based on other data included with wakeup frame 410.

Ambient device 402 can determine if its hashing result (Hash(R1∥A_ID) (calc)) matches the received hashing result (Hash(R1∥A_ID) (rcvd)) 404-1. If such hash values do not match (No from 404-1) a process can stop 404-2. If such hash values match (Yes from 404-1), ambient device 404 can pick (e.g., generate or use) its own address Aa and a random number R2 404-3. In some embodiments, an address Aa can be a randomly generated MAC address.

Ambient device 402 can also generate an encryption key K, using P 404-4. In the embodiment of FIG. 4, K can be generated by a hashing operation that includes R1, R2, Ar, Aa and P. Such a hashing operation can be the same as or different than that used to verify A_ID (404-1). Further, such a hashing operation can be predetermined (e.g., the ambient device 404 is configured to use such a hashing algorithm for the type of wakeup frame 410), or selected based on data within the wakeup frame 410. An encryption key K can be a symmetric key, suitable for decrypting data encrypted with the same key.

UL data can be encrypted using K 404-5. In some embodiments, an encryption operation that encrypts UL data can also generate an authentication code or “tag”. As but two examples, an authentication code can be generated with K using an authenticated encryption with associated data (AEAD) algorithm or keyed hash algorithm using all or a portion of K. In some embodiments, an encryption operation can also utilize a nonce value. In the embodiment shown, a nonce value can include R1+R2. In the embodiment shown, K (or a portion thereof) and R1+R2 can be encrypted with UL data. In some embodiments, an encryption algorithm used by ambient device 404 can be compatible with the AES standard or ASCON, for low power, robust encryption.

Ambient device 404 can transmit a response frame 412. A response frame 412 can include Aa as a source address, and the random address generated by reader Ar as a destination address. A payload of response frame 412 can include R1, R2, encrypted UL data (and in the embodiment shown, K and R1+R2) along with a corresponding authentication code auth_code. UL data can have been previously generated, or already present on ambient device 404. However, in alternate embodiments, all or a portion of UL data can be generated in response to wakeup frame 410.

Upon receiving response frame 412, reader 404 can determine if R1 is correct (i.e., the same R1 transmitted in the wakeup frame) and if R2 had not been repeated 402-1. A repeat of R2 can be evidence of a replay attack. If R1 is not correct or R2 is repeated (No from 402-1), a reader 404 can cease communications 402-2. If R1 is correct and R2 not repeated, reader 404 can calculate an encryption key 402-3. Such an action can include generating an encryption key in the same manner as ambient device 402.

Reader 404 can determine if an authentication code is valid 402-4. Such an action can include any validation process corresponding to that used to generate the authentication code. Accordingly, in some embodiments an encryption K can be used to validate the authentication code. If an authentication code is not valid (No from 402-4), a reader can stop communications 402-2. If an authentication code is valid (Yes from 402-4), a payload of request frame can be decrypted to yield UL data 402-5.

It is understood that all, or a portion of the actions shown for ambient device 404 in FIG. 4 can completed using ambient energy. Such ambient energy can be present in the environment as, or just prior to such actions being completed. In addition or alternatively, a portion of the actions can be executed with stored ambient energy. In some embodiments, an encryption key can be calculated and UL data encrypted with ambient energy. Operations of FIG. 4 that use ambient energy can time operations according to available ambient energy. That is, if sufficient ambient energy is not present for an operation, such an operation can be deferred until it is available.

It is also noted that in the embodiment of FIG. 4, an ambient device can perform operations involved in the single exchange that include but one encryption operation and two hashing operations for a reduced power requirement.

In this way, in response to a wakeup frame with a broadcast destination address and a source address, an ambient device can generate an encryption key and encrypt UL data with ambient energy. The encryption operation can produce an authentication code. The resulting encrypted data and authentication code can be transmitted in a response frame having the source of wakeup frame as a destination address and a random address as a source address.

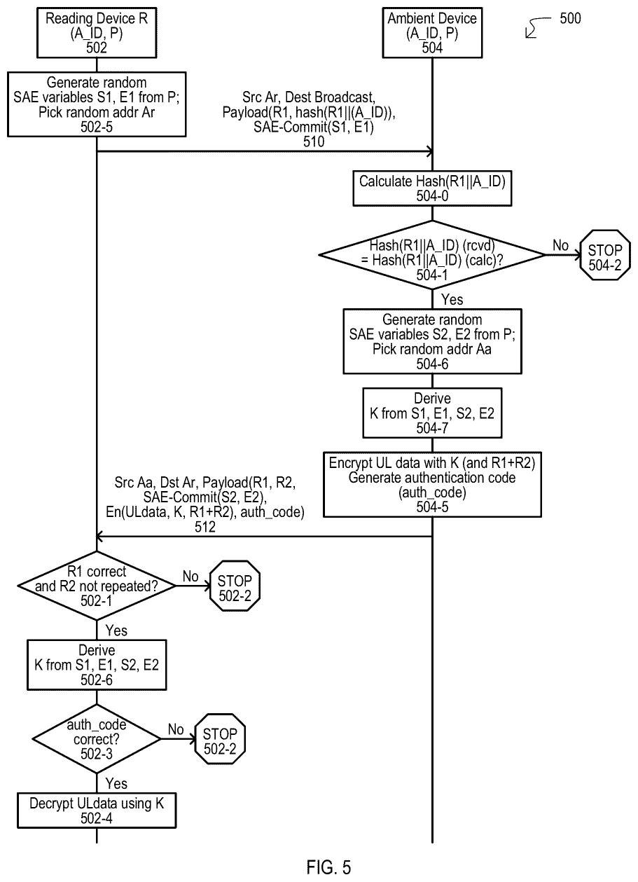

FIG. 5 is a signaling diagram of another system 500 and operations according to another embodiment. System 500 and operations can include items like those of FIG. 4, and such like items are referred to by the same reference character but with the leading digit being a “5” instead of a “4”.

System 500 and operations can differ from that of FIG. 4, in that the generation of a key and authentication code can be according to a simultaneous authentication of equals (SAE) type process. A reader 502 can generate SAE parameters, including a scalar value (S1) and an element value (E1), using a shared secret P, as well as generate a random address Ar 502-5. Values S1 and E1 can be generated according to any suitable manner, including elliptical curve cryptography and discrete curve cryptography using P directly or indirectly. Reader 502 can transmit a wakeup frame 510 that can include items like those of FIG. 4, but a payload can further include S1 and E1. In some embodiments, S1 and E1 can take the form of an SAE commit message. A wakeup frame 510 like that of FIG. 4 can be unencrypted.

Ambient device 504 operations can differ from those of FIG. 4 in that ambient device 504 can generate its own scalar (S2) and element values (E2). SAE values S2 and E2 can be generated in a fashion like that of reader 502. A type of elliptic/discrete curve cryptography can be predetermined, or alternatively, can be based on data within the wakeup frame 510. Ambient device 504 can derive an encryption key K using S1, E1, S2 and E2 504-7.

Operations of system 500 can encrypt UL data in a same or equivalent fashion as described for FIG. 4.

Ambient device 504 can transmit a response frame 512 that can include items like those of FIG. 4, but a payload can further include S2 and E2. In some embodiments, S2 and E2 can take the form of an SAE commit message.

Upon receiving a response frame 512, a reader 502 can examine R1 and R2 as described for FIG. 4. However, unlike FIG. 4, a reader 502 can derive K from S1, E1, S2, E2 502-6 in the same manner as ambient device (i.e., as shown in 504-7). Operations of system 500 can then check an authentication code 502-3 and decrypt UL data 502-4 in the same or equivalent fashion as described for FIG. 4.

In this way, an exchange between a reader and ambient device can include both devices generating their own scalar and element parameters using a shared secret. Such parameters can be exchanged and used by both devices to derive an encryption key, by which an ambient device can encrypt UL data and generate an authentication code. A reader can use the encryption key to decrypt UL data and validate the response from the ambient device.

FIGS. 6-0 and 6-1 are a signaling diagram of another system 600 and operations according to an embodiment. Connections between FIG. 6-0 and 6-1 are shown by the circles having the numbers 0, 1 and 2. System 600 and operations can include items like those of FIG. 4, and such like items are referred to by the same reference character but with the leading digit being a “6” instead of “4”.

A system 600 can differ from that of FIG. 4 in that it can include a server 622 in addition to a reader 602 and ambient device 604. A server 622 can take an suitable form, including but not limited to a computing system connected to a network (e.g., the Internet) and accessible by an address (e.g., url). A server 622 can be in possession of A_ID, and a shared secret P. Unlike FIG. 4, a reader 602 is not in possession of P. However, reader 602 is in possession of ambient device's ID (A_ID), and in addition, can stores its own ID (R_ID), its own credentials (R_cred) and an address for server 622, which in the embodiment shown can be a url (S_URL).

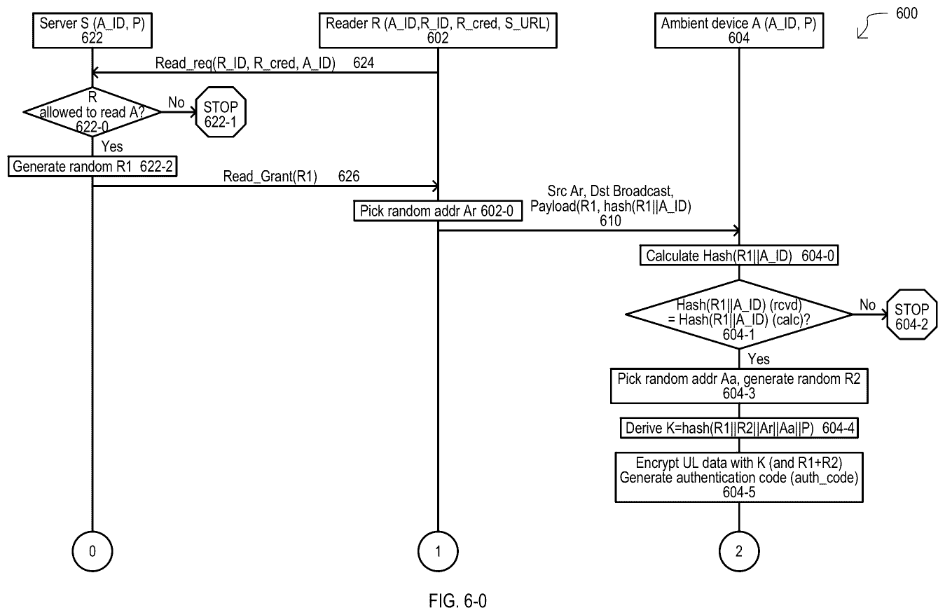

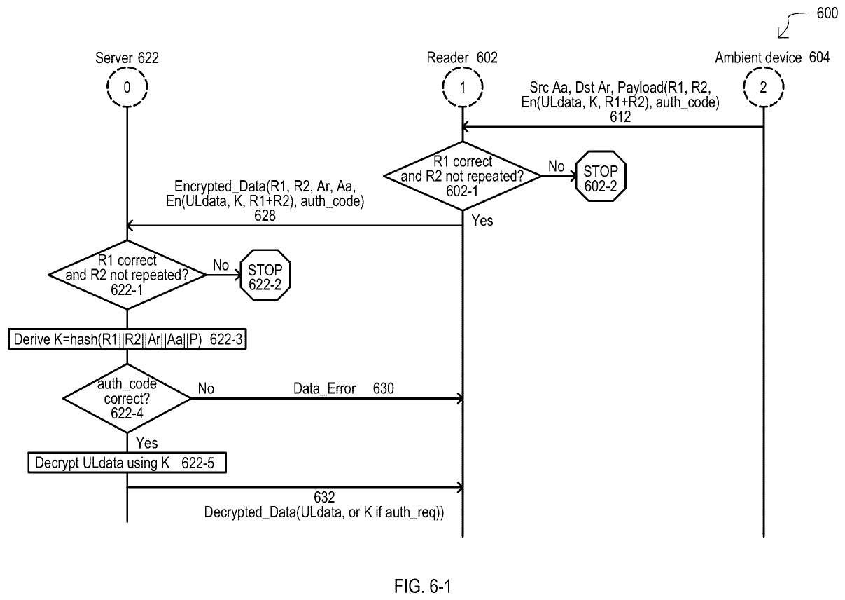

Referring to FIG. 6-0, a reader 602 can transmit a read request 624 to server 622. A read request 624 can include R_ID, R_cred and A_ID). A read request 622 can take any form suitable to a network connecting server 622 and reader 602, in the embodiment shown can be compatible with and Internet transmission addressed to S_URL. A read request 622 can be transmitted over a secured connection, such as a that created by establishing a transport layer security (TLS) connection.

In response to receiving read request 624, server 622 can determine if reader 602 is authorized to communicate with ambient device 622-0. Such a determination can be based all, or in part, on the R_ID, R_cred and A_ID values received in the read request. If server 622 determines that reader 602 is not authorized to communicate with authentication device (No from 622-0), server 622 can cease communications 622-1.

If server 622 determines that reader 602 is authorized to communicate with authentication device (Yes from 622-0), server 622 can generate a random number R1 622-2, and then transmit a read grant message 626. Read grant message 626 can include R1. A read grant message can be transmitted over the same type of secure connection as the read request 624.

Upon receiving read grant 626, reader 602 can operate in the same general fashion as FIG. 3, picking a random address 602-0 and transmitting a wakeup frame 610. Upon receiving wakeup frame 610, ambient device 604 can operate in the same fashion as FIG. 3, calculating a hash with R1 and A_ID 604-0, comparing hash values 604-1, generating its own random address Aa and random number R2 604-3, deriving an encryption key K 604-4, and encrypting UL data and generating an authentication code 604-5.

Referring to FIG. 6-1, like FIG. 4, ambient device 604 can transmit a response frame 612 to reader 602. Also like FIG. 4, reader 602 can check if R1 is valid and R2 is not repeated 602-1.

Unlike FIG. 4, if reader determines that R1 is correct and R2 is not repeated, reader 602 can transmit a forwarded response 628 to server 622. A forwarded response 628 can include all the data in the response message 612 received from ambient device 602. A forwarded response 628 can be encrypted and transmitted over the same type of connection as read request 624 and/or read grant 626. In some embodiments, a forwarded response 628 can also serve as an authentication request to a server.

Upon receiving forwarded response 628, a server 622 can also determine if R1 is correct (i.e., the same as that transmitted in the read grant 626) and that R2 has not been repeated (to defeat a replay attack) 622-1. If server 622 determines R1 is not valid or R2 is repeated (No from 622-1), a server 622 can end communications with reader 602 622-2. If server 622 determines R1 is valid and R2 is not repeated (Yes from 622-1), a server 622 can calculate an encryption key K 622-3, and check an authentication code 622-4. If an authentication code is not valid (No from 622-4), server 622 can transmit an error message 630 to reader 602. Such a message can be transmitted over the type of connection used for a read grant 626. From error message 630, reader 604 can determine that communication should not continue with the (perceived) ambient device 602. If an authentication code is valid (Yes from 622-4), server 622 decrypt UL data 622-5 and then transmit a server message 632. In some embodiments, a server response message 632 can include decrypted UL data. In other embodiments, for example if a reader 604 sent an authentication request, a server message 632 can include encryption key. A server message 632 can be transmitted over a secure connection like that used for read grant 626.

As in the case of the embodiment of FIG. 4, in system 600, an ambient device 604 may execute only one encryption operation and two hash operations for a relatively small power requirement.

In this way, a reader can send a read request to a server device to be validated for access to an ambient device, and receive a read grant message that includes a random number. The reader can generate a wakeup frame that includes the random number. In response to the wakeup frame an ambient device can provide a response frame with encrypted UL data. A reader can transmit the encrypted UL data to the server and receive decrypted UL data from the server.

FIGS. 7-0 and 7-1 are a signaling diagram of another system 700 and operations according to an embodiment. Connections between FIG. 7-0 and 7-1 are shown by the circles having the numbers 0, 1 and 2. System 700 and operations can include items like those of FIGS. 5 and 6-0/1, and such like items are referred to by the same reference character but with the leading digit being a “7” instead of “5” or “6”.

A system 700 can include a server 722, reader 702 and ambient device 704 like those of FIGS. 6-0/1. A system 700 can differ from that of FIG. 6 in that a server 722, after determining that reader 702 is allowed to communicate with ambient device 702, can generate random SAE variables S1 and E1, based on P 722-7. Such actions can occur as described in FIG. 5, 502-5, but are performed by a server 702. A server 722 can transmit a read grant 726, like that of FIGS. 6-0/1, but such a read grant can include SAE parameters S1, E1 in addition to random number R1.

Upon receiving a read grant 726, a reader 702 pick a random address 702-0 and transmit a wakeup message 712, as described for 602-0 and 612 of FIG. 6-0. However, unlike FIG. 6-0, wakeup message 712 can further include SAE variables S1 and E1, in an SAE commit message, for example.

In response to wakeup message 712, ambient device 702 can calculate a hash value 704-0, compare hash values 704-1, generate SAE random parameters using P 704-6, derive encryption key 704-7, and encrypt UL data 704-5, in a manner like that of FIG. 5.

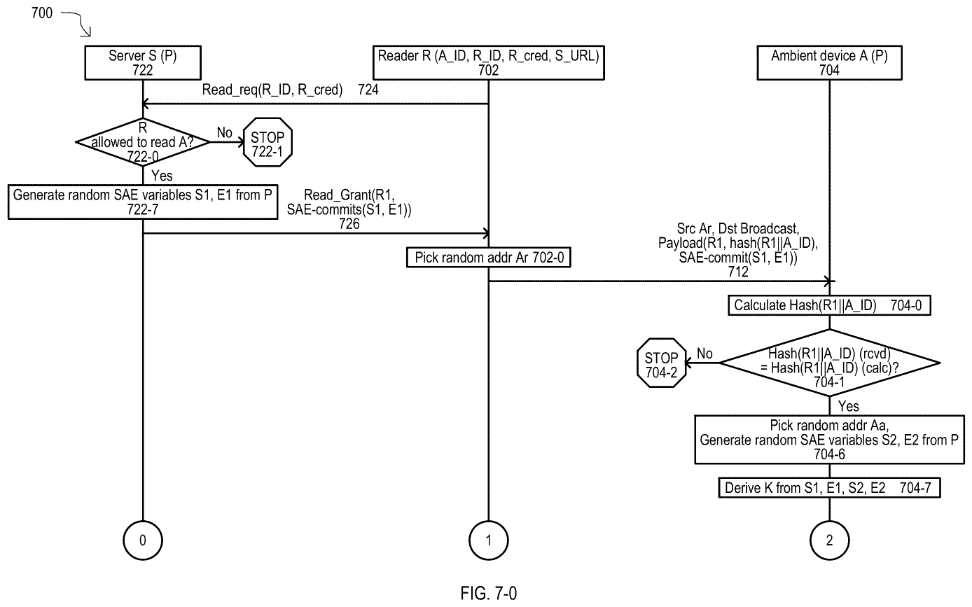

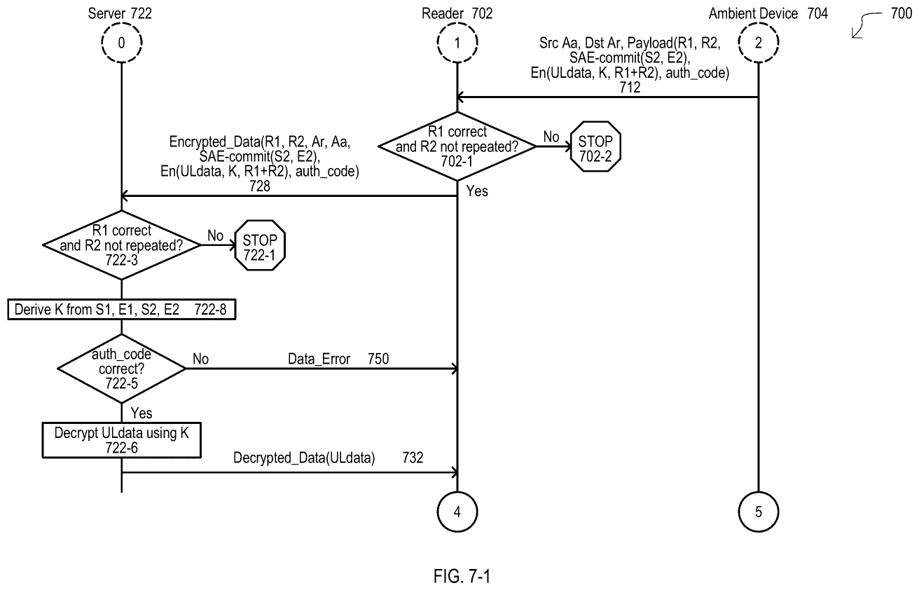

Referring to FIG. 7-1, an ambient device 702 can transmit a response frame 712 in the same manner as FIG. 5. Upon receiving response frame 712, a reader 704 can evaluate R1 and R2 702-1 and transmit a forwarded response 728 in the same fashion as FIG. 6-1.

Upon receiving forwarded response 728, server 722 can evaluate R1 and R2 722-3 in the same fashion as FIG. 6-1. However, unlike FIG. 6-1, server 722 can derive K from S 1, E 1, S 2, E 2 722-8. Server 722 can then evaluate the authentication code received with the forwarded response 722-5 and decrypt UL data using K 722-6. Such actions can take the form of those shown in FIG. 6-1.

It is noted, in some embodiments, where a size of frames (e.g., wakeup frame and/or response frame) is limited, in the above operations, R1 and R2 can be replaced with S1 and S2, thus reducing a size of a frame. This can apply to other embodiments herein that utilize an SAE type exchange.

In this way, a reader can transmit a wakeup frame with first SAE random variables received from a server. An ambient device can generate second SAE variables, encrypt UL data with an encryption key generated using first and second SAE random variables. Ambient device can transmit a response frame to reader that includes second SAE random variables and encrypted UL data. A reader can forward the response frame to the server, which can return decrypted UL data.

FIGS. 8-0 and 8-1 are signaling diagrams of a system 800 and operations according to another embodiment. Connections between FIG. 8-0 and 8-1 are shown by the circles having the numbers 1 and 2. A system 800 and operations can include items like those of FIG. 4, and such like items are referred to by the same reference characters but with the leading digit being an “8” instead of a “4”.

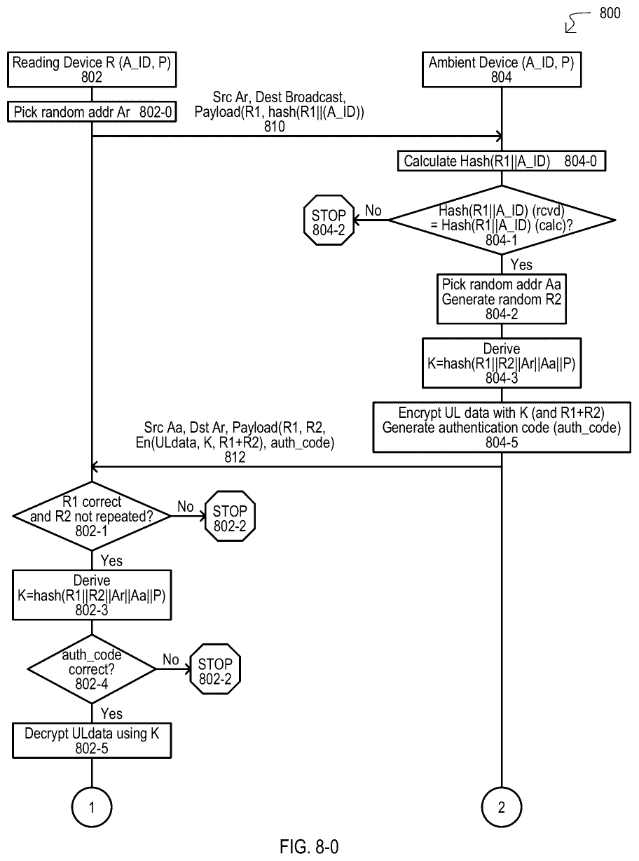

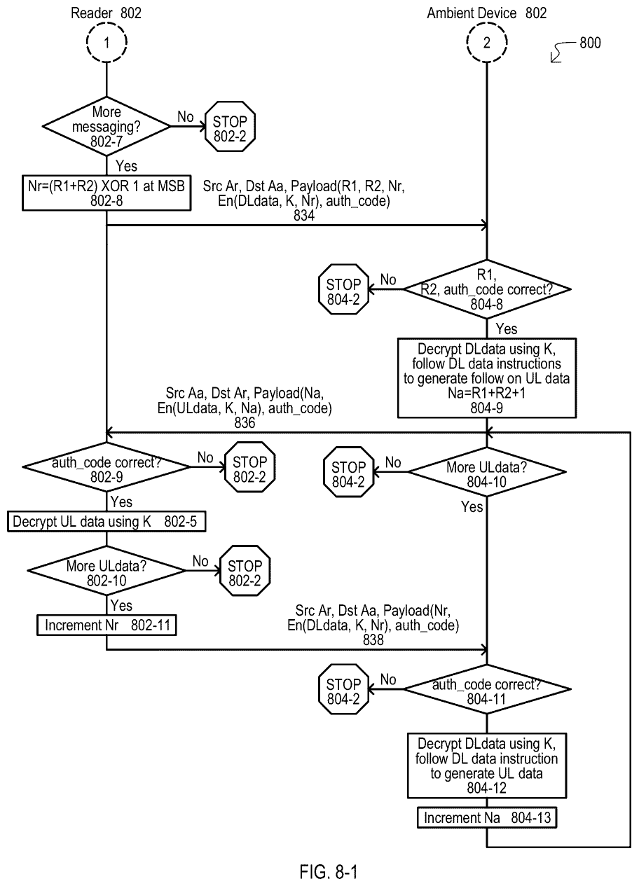

Referring to FIG. 8-0, operations of system 800 follow the operations of FIG. 4.

Referring to FIG. 8-1, once a reader 802 and ambient device 804 have exchanged a wakeup frame 810 and response frame 812, a reader 802 can determine if more messaging is to occur 802-7. Such an action can occur in the event decrypted UL data indicates an authentication request. If more messaging is not indicated (No from 802-7), a reader 802 can stop messaging with an ambient device 803.

If more messaging is indicated (Yes from 802-7), a reader 802 can generate a transaction count value Nr 802-8. In the embodiment of FIGS. 8-0/1, a transaction count value can be generated by adding R1 and R2, and XORing a most significant bit (MSB) location with a 1. A reader 802 can then encrypt downlink (DL) data, and transmit such data to an ambient device 802 in a follow-on frame 834. In some embodiments, DL data can be encrypted with K, but using Nr as a nonce. In the embodiment shown, a follow-on frame 834 can have a payload that includes R1, R2, Nr and an encoded portion that includes DL data, K, Nr, along with a corresponding authentication code.

Upon receiving DL frame 834, ambient device 802 can determine that R1 and R2 are correct, and validate the frame with the authentication code 804-8. In some embodiments, an authentication code can be validated with encryption key K. If any of R1, R2 or the authentication code are determined to be invalid (No from 804-8), ambient device 802 can cease communications with the reader 804-2. If R1, R2 and the authentication code are valid (Yes from 804-8), DL data can be decrypted, and according to DL data instructions, follow-on UL data can be generated, and an ambient device count value can be generated Na 804-9. In some embodiments, DL data can be decrypted using K and Nr as a nonce value. In some embodiments, an ambient device count value Na can be R1+R2+1.

Ambient device 804 can then encrypt follow-on UL data, and transmit such data to a reader 802 in a follow-on response frame 836. In some embodiments, follow-on UL data can be encrypted with K, but using Na as a nonce. In the embodiment shown, a follow-on response frame 836 can have a payload that includes Na and an encoded portion that includes follow-on UL data, K, Na, along with a corresponding authentication code.

Upon receiving follow-on frame 836, a reader 804 can validate it with the included authentication code 802-9. In some embodiments, an authentication value can be validated using K. Follow-on UL data can be decrypted using K 802-5. In some embodiments, such decryption can use K and Na. Decrypted follow-on UL data can be consumed by reader 802 to determine if a reader 802 expects more UL data from ambient device 802-10. If no more UL data is expected (No from 802-10), a reader 802 can cease communications with ambient device 802.

If more UL data is expected (Yes from 802-10), a reader 802 can increment a transaction count value Nr 802-11. A reader 802 can then encrypt new DL data, and transmit such data to an ambient device 802 in a further follow-on frame 838. In some embodiments, DL data can be encrypted with K, but using Nr as a nonce. In the embodiment shown, further follow-on frame 838 can have a payload that includes Nr and an encoded portion that includes DL data, K, Nr, along with a corresponding authentication code.

Upon receiving further follow-on frame 838, ambient device 804 can validate the frame with the authentication code 804-11. In some embodiments, an authentication code can be validated with encryption key K. If the authentication code is invalid (No from 804-11), ambient device 802 can cease communications with the reader 804-2. If the authentication code is valid (Yes from 804-11), follow-on DL data can be decrypted, and according to DL data instructions, further follow-on UL data can be generated 804-12. An ambient device count value Na can be incremented 804-13. In some embodiments, DL data can be decrypted using K and Nr as a nonce value. Ambient device 804 can then encrypt follow-on UL data, and transmit such data to a reader 804 in a follow-on frame (i.e., return to action 836).

FIGS. 9-0 and 9-1 are signaling diagrams of a system 900 and operations according to another embodiment. Connections between FIG. 9-0 and 9-1 are shown by the circles having the numbers 1 and 2.

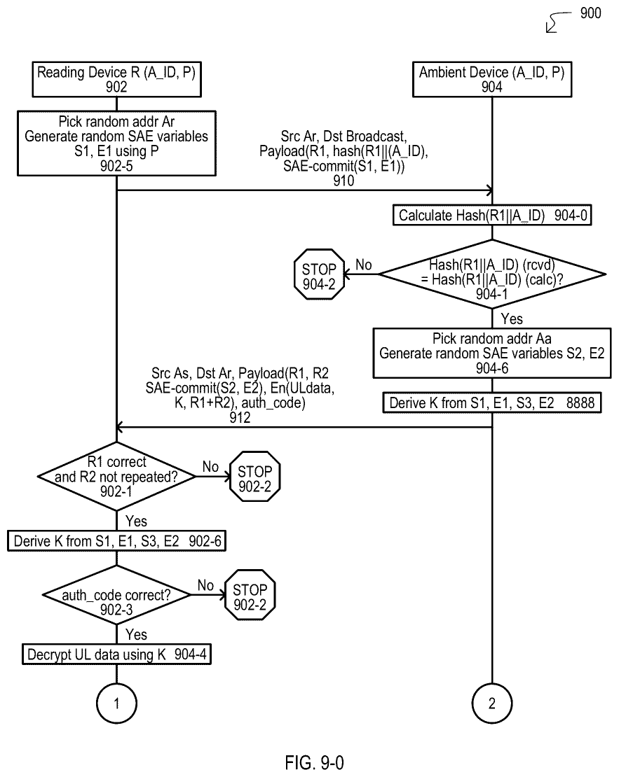

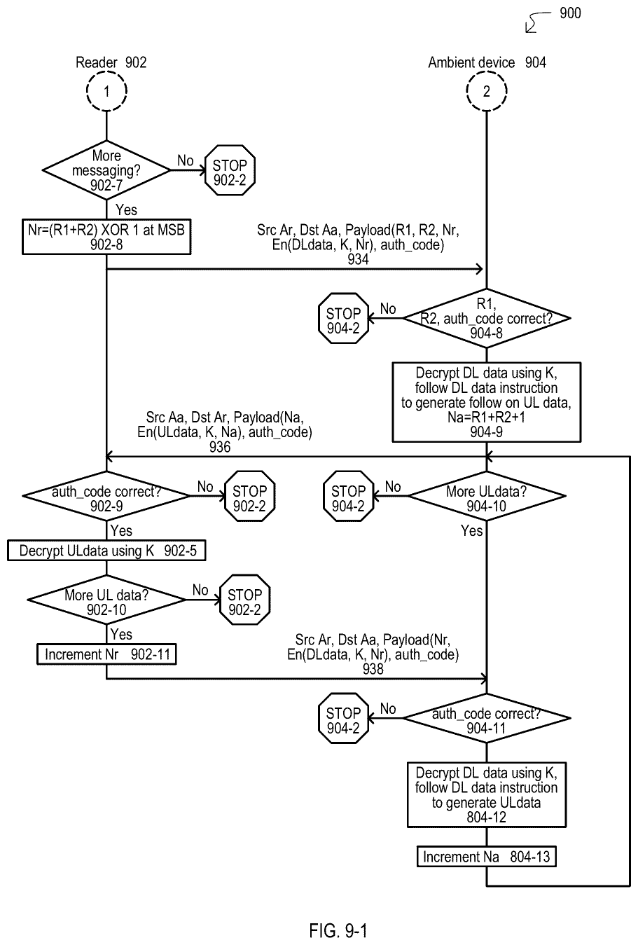

Referring to FIG. 9-0, a system 900 and operations can include items like those of FIG. 5, and such like items are referred to by the same reference characters but with the leading digit being an “9” instead of a “5”.

Referring to FIG. 9-1, a system 900 and operations can include items like those of FIG. 8-1, and such like items are referred to by the same reference character but with the leading digit being a “9” instead of an “8”.

In this way, a reader and ambient device that can execute a single exchange to provide encrypted UL data to from the ambient device to a reader, and then extend a number of exchanges for interactions that can require more than one exchange, such as an authentication request.

FIGS. 10-0, 10-1 and 10-2 are flow diagrams showing a system 1000 and operations according to a further embodiment. Connections between FIG. 10-0 and 10-1 are shown by the circles having the numbers 0, 1 and 2. Connections between FIG. 10-1 and 10-2 are shown by the circles having the numbers 1 and 2.

Referring to FIGS. 10-0 and 10-1, a system 1000 and operations can include items like those of FIGS. 6-0 and 6-1, and such like items are referred to by the same reference characters but with the leading digits being “10” instead of a “6”.

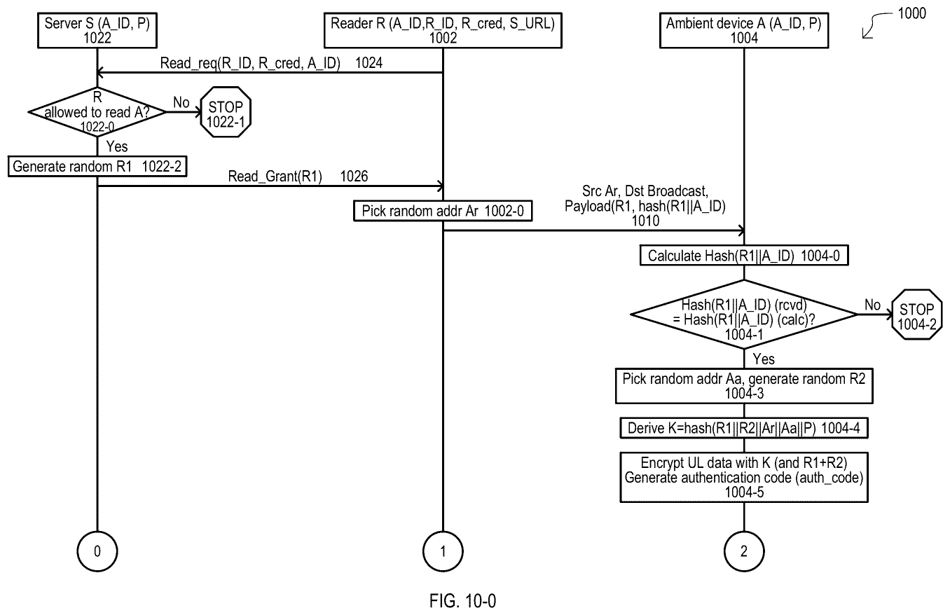

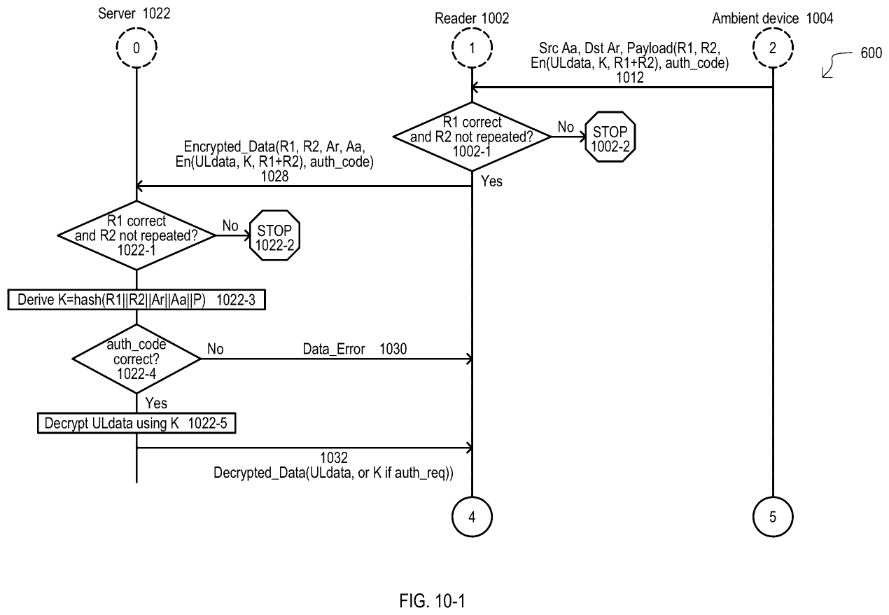

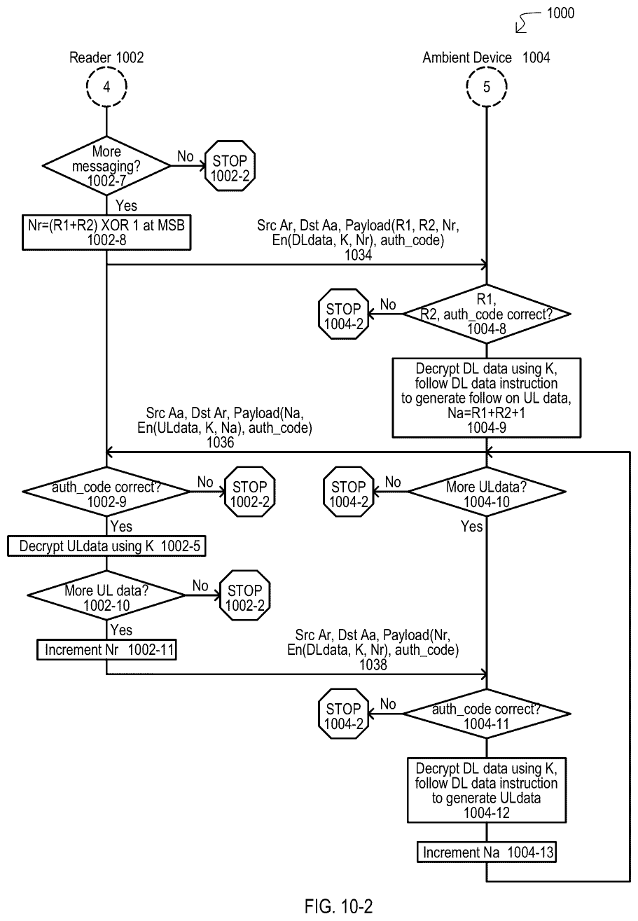

Referring to FIG. 10-2, a system 1000 and operations can include items like those of FIG. 8-1, and such like items are referred to by the same reference character but with the leading digits being “10” instead of an “8”.

FIGS. 11-0, 11-1 and 11-2 are flow diagrams showing a system 1100 and operations according to a further embodiment. Connections between FIG. 11-0 and 11-1 are shown by the circles having the numbers 0, 1 and 2. Connections between FIG. 11-1 and 11-2 are shown by the circles having the numbers 4 and 5.

Referring to FIGS. 11-0 and 11-1, a system 1100 and operations can include items like those of FIGS. 7-0 and 7-1, and such like items are referred to by the same reference characters but with the leading digits being “11” instead of a “7”.

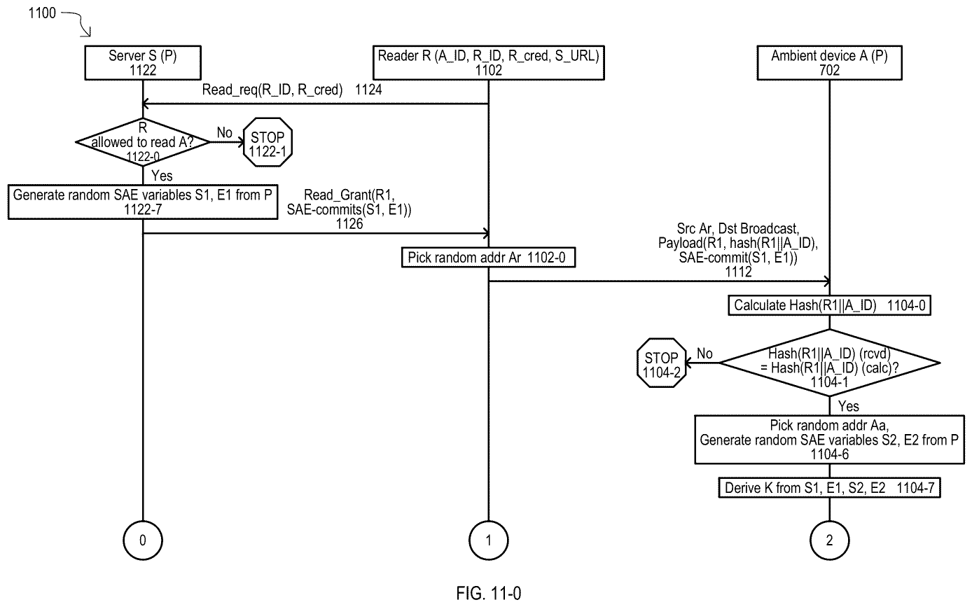

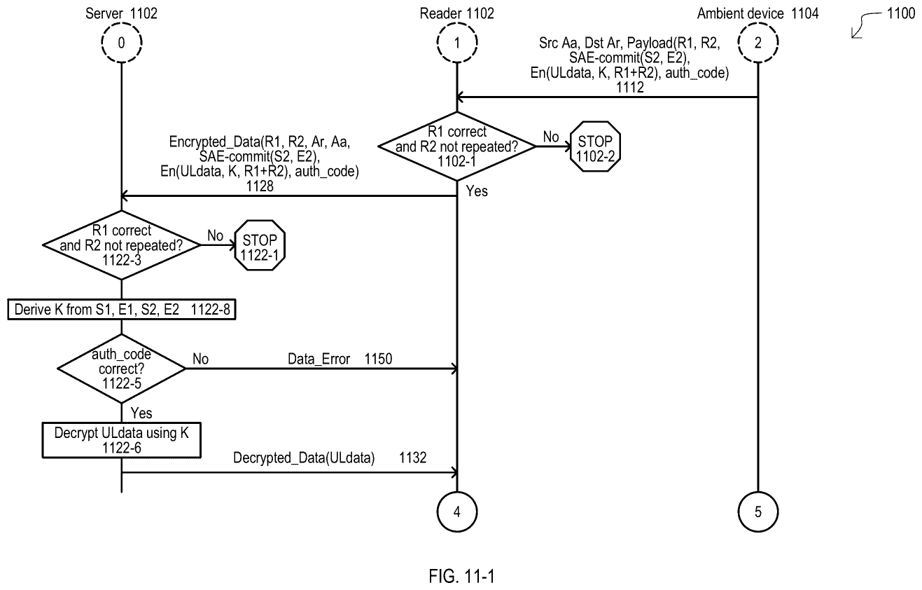

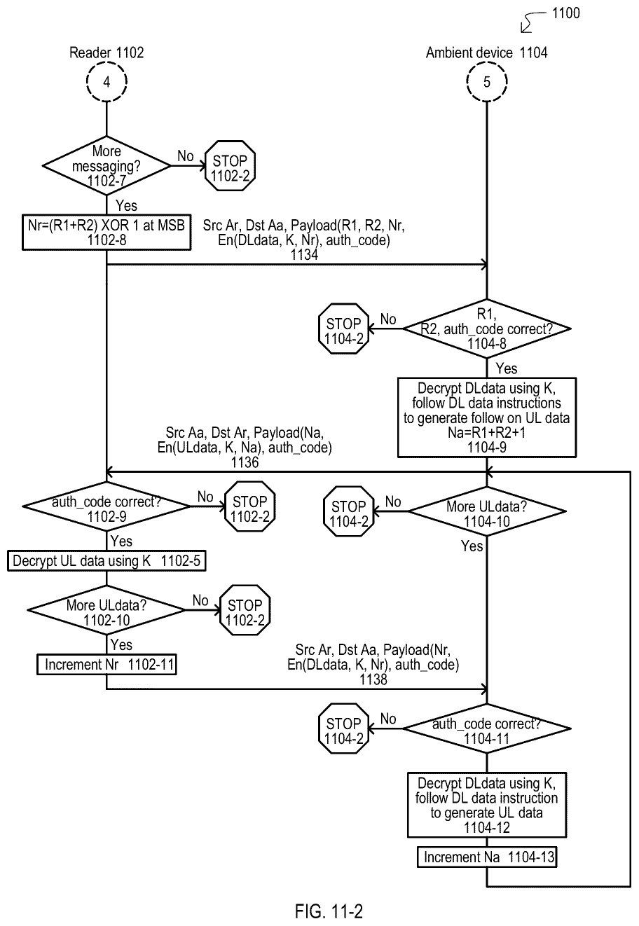

Referring to FIG. 11-2, a system 1100 and operations can include items like those of FIG. 8-1, and such like items are referred to by the same reference character but with the leading digits being “11” instead of an “8”.

In this way, in systems in which a reader must be validated by a server before executing a single exchange to provide encrypted UL data to from the ambient device to a reader, can extend a number of exchanges for interactions that can require more than one exchange, such as an authentication request.

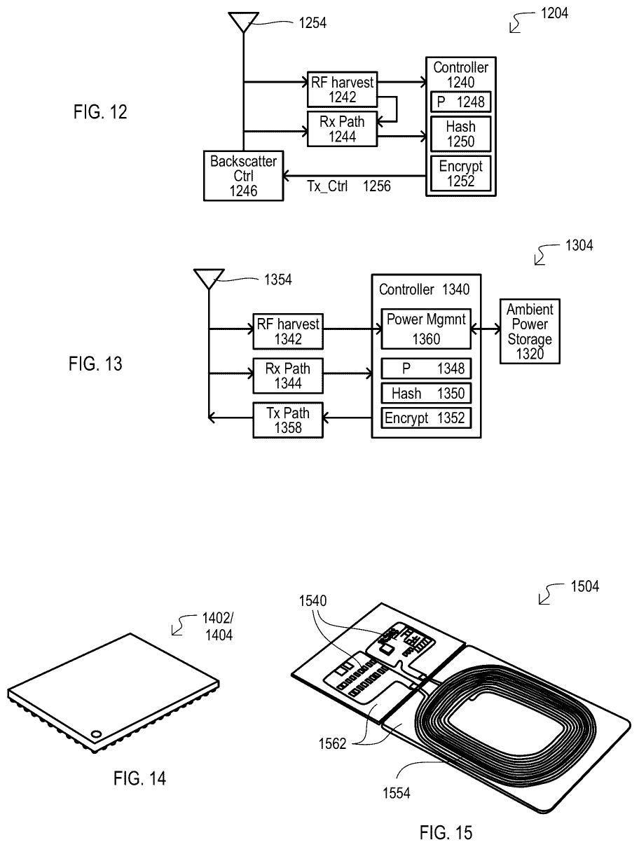

FIG. 12 is a block diagram of an ambient device 1204 according to an embodiment. Ambient device 1204 can include controller circuits 1240, RF harvester circuits 1242, receive (Rx) path 1244, and backscatter controller 1246. Controller circuits 1240 can include any suitable circuits for executing communications described for ambient devices herein, including but not limited to, one or more processing circuits, including instructions, custom logic, programmable logic, and combinations thereof. Controller circuits 1240 can include a state machine, a sequencer and/or some other type of control circuit, which may be implemented in the form of hardware, firmware, software, or combinations thereof. Ambient device 1204 can be connected to an antenna system 1254. Antenna system 1254 can include one or more antennas, and can be tuned, or capable of being tuned by RF harvester 1242 and/or backscatter controller 1246 to receive ambient RF energy and/or reflect ambient energy (e.g., generate backscatter messages).

Controller circuits 1240 can store a secret value P 1248, and using ambient energy from RF harvester circuit 1242, execute two or more hashing operations 1250 and/or one or more encryption/decryption operations 1252. In some embodiments, hashing operations 1250 can include a cryptographic hash function that can use P 1248 as a key. Encryption/decryption operations 1252 can include generating K according to any of the embodiments herein, including but not limited cryptographic hash operations that utilize P 1248 as a key value. In addition or alternatively, encryption/decryption 1252 can include elliptical and/or discrete curve cryptography that can use P 1248 as a seed or related value.

Controller circuits 1240 can generate and transmit, via backscatter controller 1246, messages, including but not limited to, response messages corresponding to wakeup messages from a reader device, as described herein, or equivalents.

RF harvester circuits 1242 can include circuits for receiving RF energy and converting it into energy for use by controller circuits 1240 and Rx path 1244. RF harvester circuits 1242 can include impedance circuits that match, or can be configured to match, ambient RF energy. Rx path 1244 can include circuits configured to receive messages from a reader device, such as messages according to one or more standards. In some embodiments, Rx path 1244 can be compatible with one or more IEEE 802.11 wireless standards.

Backscatter controller 1246 can receive transmit control (Tx_Ctrl) signals 1256 from controller circuits 1230. In response to Tx_Ctrl signals 1256, backscatter controller 1246 can alter an impedance of antenna system 1254 that can result in transmission of a message (e.g., data frame) in response to ambient energy.

In this way, an ambient device can calculate hashing operations and encryption operations with ambient energy and generate response messages by altering an antenna impedance.

FIG. 13 is a block diagram of an ambient device 1304 according to an embodiment. Ambient device 1304 can include items like those of FIG. 12, and such like items are referred to by the same reference character but with the leading digits being “13” instead of “12”.

Ambient device 1304 can differ from that of FIG. 12 in that it can include a Tx path 1358, ambient power storage 1320, and controller circuits 1340 can include power management circuits 1360. A Tx path 1358 can enable controller circuits 1340 to transmit messages via antenna system 1354. Ambient power storage 1320 can store ambient RF energy acquired by RF harvester circuits 1342.

Power management circuits 1360 can control the distribution of ambient power received by RF harvester circuits 1342. This can include providing power to controller circuits 1340 to execute the indicated operations (e.g., hashing 1350, encryption 1352). In some embodiments, power management circuits 1360 can provide power from ambient power storage 1320 or RF harvester circuit 1342. Accordingly, when transmitting a response message via Tx path 1358, ambient device 1304 can utilize ambient power provided by RF harvester circuits 1342, energy stored in ambient power storage 1320, or a combination thereof.

In this way, an ambient device can calculate hashing operations and encryption operations with ambient energy currently present in the environment and/or stored ambient energy.

While embodiments can ambient devices with various interconnected components, embodiments can also include ambient devices which can execute low power single exchanges using ambient energy as described herein and equivalents. In some embodiments, such unitary devices can be advantageously compact single integrated circuits (IC). FIG. 14 shows a packaged IC device 1402/1404 that can execute communications as a reader device or ambient device according to embodiments shown herein and equivalents. While FIG. 14 shows a particular package, alternate embodiments can include any other suitable integrated circuit packaging type, as well as direct bonding of a device chip onto a circuit board or substrate.

In this way, an ambient device or reader as described herein can take the form of an integrated circuit device.

FIG. 15 is a diagram showing an ambient device 1504 according to another embodiment. An ambient device 1504 can include one or more support structures 1562, controller circuits 1540 and an antenna system 1554. Controller circuits 1540 can include one or more IC packages and well as other components. Such other components can include those for providing suitable impedance values for antenna system 1554, including inductors, capacitors and/or resistors. Such components may be configurable by controller circuits 1540. Support structure 1562 can provide a surface on which components of controller circuits 1540 can be mounted and electrically interconnected. In some embodiments, a support structure 1562 can include one or more circuit boards. Optionally, support structure 1562 can include a surface that connects to, or contains all or a portion of antenna system 1554. An antenna system 1554 can be capable of harvesting ambient RF energy, as well as transmitting response frames, as described herein or equivalents.

In this way, an ambient device can include one or more integrated circuit devices and other circuit components mounted on a support structure connect to, or including an antenna system.

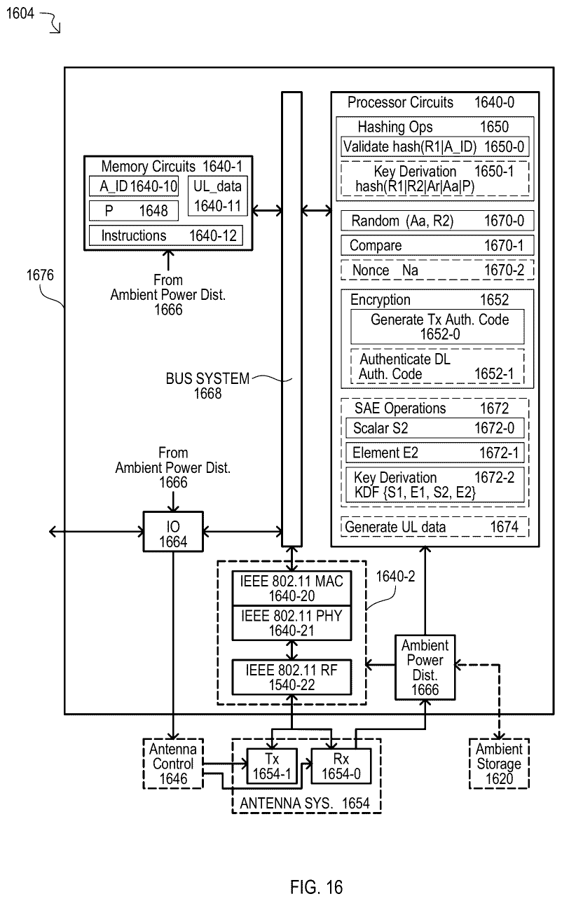

FIG. 16 is a block diagram of an ambient device 1604 according to another embodiment. In some embodiments, an ambient device 1604 can be one implementation of either of those shown in FIGS. 12, 13, 14 or 15. A ambient device 1604 can include items like those of FIG. 12, and such like items are referred to by the same reference characters but with the leading digit being a “16” instead of “12”.

Ambient device 1604 can include controller circuits (1640-0, -1, -2), IO circuits 1664 and ambient power distribution circuits 1666 connected to one another over a backplane/bus 1668. Controller circuits can include processor circuits 1640-0, memory circuits 1640-1, and wireless circuits 1640-2. Processor circuits 1640-0 can include one or more processors that can execute instructions to provide various functions for ambient device 1640.

Operations provided by processor circuits 1640-0 can include, but are not limited to, hashing operations 1650, random number generation 1670-0, compare operations 1670-1, and encryption operations 1652. In some embodiments, processor circuits 1640-0 may also provide for nonce generation 1670-2, SAE type operations 1672, and the generation of UL data 1674. Hashing operations 1650 can include validate hashing 1650-0 which can generate a hash value to validate a received message (e.g., using A_ID and a received R1). Optionally, hashing operations 1650 can include a key derivation operation (e.g., using R1, R2, Ar, Aa and P) 1650-1.

Random number generation 1670-0 can generate random numbers for various application, including but not limited to generating a random address (e.g., random MAC address) for messages and for validation and/or in the creation of a nonce (e.g., R2). Compare operations 1670-1 can compare values, including but not limited to hash results for validating messages (e.g., R1|A_ID) and/or authentication codes for authenticating messages (e.g., auth_code). Nonce generation 1670-2 can generate nonce as described herein that can indicate sequences of messages (e.g., Na). Encryption operations 1652 can encrypt UL data with K for transmission in response messages as described herein and equivalents, including generating a corresponding authentication code (e.g., AEAD). Optionally, encryption operations can include decrypting DL data received from a reader.

Optional SAE operations 1672 can include generating S2 and E2 values according to a discrete and/or elliptic cryptographic function, for example. SAE operations 1672 can also include deriving a key using at least received values (e.g., S1, E1) and generated values (e.g., S2, E2). Optionally, processor circuits 1640-0 can generate UL data 1674. UL data can be generated in response to wakeup messages and/or decrypted DL data.

Memory circuits 1640-1 can include any suitable memory circuits, including nonvolatile memory, volatile memory or combinations thereof. Memory circuits 1640-1 can store a device ID (A_ID), 1640-10, a secret value P 1648, UL data 1640-11, and instructions 1640-12 corresponding to operations of processor circuits 1640-0. Wireless circuits 1640-2 can include circuits for transmitting and receiving messages according to one or more IEEE 802.11 wireless standards. In the embodiment shown, wireless circuits 1640-2 can include MAC layer circuits 1640-20, physical layer (PHY) circuits 1640-21, and RF circuits 1640-22.

IO circuits 1662 can input or output signals that can enable control of an ambient device 1604 from external sources. In some embodiments, IO circuits 1662 can include serial communication circuits, including but not limited to interfaces compatible with a serial digital interface (SDI), universal serial bus (USB), universal asynchronous receiver transmitter (UART), I2C, or I2S.

Ambient power distribution circuits 1666 can receive ambient power and distribute it to various sections of ambient device 1604. Ambient power distribution circuits 1666 can receive ambient power from antenna system 1654, ambient storage 1620, or combinations thereof.

In some embodiments, controller circuits (1640-0/1/2), IO circuits 1664, and ambient power distribution circuits 1620 can be formed with a same IC substrate 1676.

Ambient device 1604 can be connected to antenna system 1654 that includes one or more Rx paths 1654-0 and one or more Tx paths 1654-1. A Rx path 1654-0 can receive wakeup and follow-on messages from a reader. An Rx path 1654-0 can also receive ambient power and transmit such power to ambient power distribution circuits 1666. A Tx path 1654-1 can transmit response messages, and optionally, follow-on response messages as described herein and equivalents.

Optionally, ambient device 1604 can be connected to and/or include an antenna control system 1646. An antenna control system 1646 can alter an impedance of a receive path 1654-0 and optionally a transmit path 1654-1. In some embodiments, antenna control system 1646 can receive control signals from processor circuits 1640-0 via IO circuits 1664, however, in alternate embodiments control signals can be received directly from processor circuits 1640-0. In some embodiments, antenna control circuits 1646 can alter an impedance of a Rx path 1654-0 to generate a response message using ambient energy (e.g., modulating reflected energy).

In this way, an ambient device can be compatible with one or more IEEE 802.11 wireless standards, and can execute hashing and encryption operations with ambient energy to encrypt and transmit DL data.

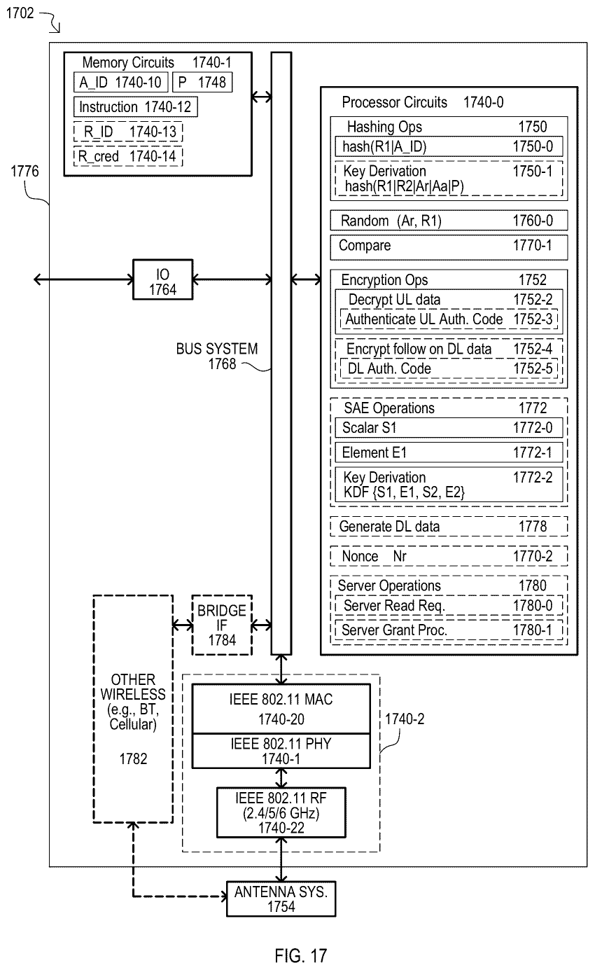

FIG. 17 is block diagram of a reader 1702 according to another embodiment. A reader 1702 can include items like those of FIG. 16, and such like items are referred to by the same reference character but with the leading digits being “16” instead of “17”.

FIG. 17 can differ from FIG. 16 in that random number generation can generate a random address (e.g., MAC address) value for reader (Ar) and its own random value for an ambient device to validate a message (e.g., R1). Encryption operations 1752 can differ in that they can include decrypting UL data 1752-2. In some embodiments, such an operation can also include authenticating an authentication code (1752-3) received with UL data. In some embodiments, encryption operations 1752 can further include encrypting follow-on DL data 1752-4 (e.g., for an extended authentication operation) and generating a corresponding authentication code 1752-5.

Optional SAE operations 1772 can differ from FIG. 16 in that reader 1702 can generate its own parameters, S1 1772-0 and E1 1772-1. A reader 1702 can generate DL data 1778 for encryption and transmission in follow-on messages. Nonce generation 1770-2 can include a nonce generated for follow-on operations.

In some embodiments, a reader device 1702 can include server operations 1780. Server operations 1780 can enable a reader 1702 to communicate with one or more servers over a network. In some embodiments, server operations 1780 can enable a reader device 1702 to access the Internet and exchange secure communications (e.g., TLS) with one or more servers. In some embodiments, server operations 1780 can include generating a server read request 1780-0 as well as processing server grant messages 1780-1, as described herein and equivalents.

Memory circuits 1740 can store instructions 1740-2 for execution by processor circuits 1740-0 for the various operations described, or equivalents. Memory circuits 1740 can optionally store a reader ID value 1740-13 and reader credentials 1740-14 for to establish a connection with a server, as described herein and equivalents.

In this way, a reader can be compatible with one or more IEEE 802.11 wireless standards, and can execute hashing and encryption operations for communications with an ambient device.

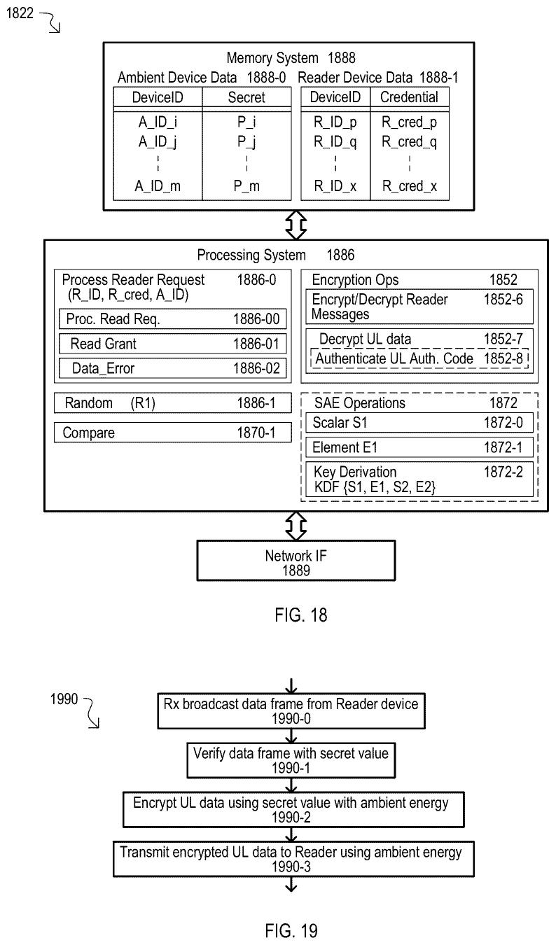

FIG. 18 is a block diagram of a server 1822 according to an embodiment. A server 1822 can include a processing system 1886, memory system 1888 and network interface (IF) 1889. Processing system 1886 can include one or more computing systems that can execute instructions to provide various server operations in support of ambient device communications as described herein and equivalents. Such server operations can include, but are not limited to, processing reader requests 1886-0, generating random numbers 1886-1, compare operations 1870-1, encryption operations 1852 and optionally, SAE operations 1872. Processing reader requests 1886-0 can include establishing a secure connection (e.g., TLS) with a reader to receive a request, and extracting values (e.g., R_ID, R_cred) from the read request to determine if the reader should be granted access. Generating read grants 1886-01 can include generating a message that can be returned to a reader over a secure connection that includes values (e.g., R1) for accessing an ambient device. Data error messages 1886-02 in response to reader messages that fail to include valid ambient device data.

Generating random numbers 1886-1 can include generating a random number (e.g., R1) for inclusion in a read grant message, and for forwarding to an ambient device by a reader. Compare operations 1870-1 can include those described for FIG. 16 (e.g., a received R1 is the same as that sent, R2 is not a recent repeat). Encryption operations 1852 can include, but are not limited to, decrypting and encrypting reader messages 1852-6. Such operations can include encryption/decryption according to a cipher suite established by a handshake procedure with a reader (e.g., TLS). Encryption operations 1852 can further include decrypting UL data 1852-7. Such operations can include generating an encryption key K using a secret P, where K is symmetric with one known to an ambient device but not an intervening reader. Optionally, a frame with UL data can be authenticating with an authentication code received with the frame. SAE operations 1872 can include described for FIG. 17.

Memory system 1888 can store values for access by processing system 1886 when communicating with a reader. Memory system 1888 can store ambient device data 1888-0 and reader data 1888-1. Ambient device data 1888-0 can include device ID and secret value pairs (e.g., A_ID_i/P_i, A_ID_j, P_j) for multiple ambient devices. Similarly, reader data 1888-1 can include reader device ID and credential pairs (R_ID_p/R_cred_p, R_ID_q/R_cred_q).

A network IF 1889 can enable communications between server 1822 and readers. In some embodiments, a network IF 1889 can be connected to the Internet, and readers can communicate with server 1822 with IP packets.

In this way, a server can store reader IDs and credentials to validate read requests from reader devices, as well as ambient device IDs and shared secrets with ambient devices to be accessed by such reader devices.

While the systems, operations and devices herein have shown various methods, additional methods will now be described with reference to a number of flow diagrams.

FIG. 19 is a flow diagram of a method 1990 according to an embodiment. A method 1990 can be executed by an ambient device as described herein and equivalents. A method 1990 can include receiving a broadcast data frame from a reader 1990-0. In some embodiments, such an action can include detecting a frame with a destination address having a predetermined value (e.g., broadcast or multi-cast network address). A received data frame can be verified with a secret value 1990-1. In some embodiments, such an action can include using a predetermined hashing operation. UL data can be encrypted using a secret value and ambient energy 1990-2. Such an action can include generating a symmetric according to any of the embodiments described herein and equivalents. Encrypted DL data can then be transmitted to a reader 1990-3. Such an action can include transmitting a response frame as described herein and equivalents. Ambient energy can be ambient transmission currently in the environment and/or stored in a storage device.

In this way, a method can include, in response to a broadcast data frame, encrypting UL data and transmitting such data in a message using ambient energy.

FIGS. 20-0 and 20-1 are flow diagrams showing a method 2090 according to another embodiment. Connections between FIG. 20-0 and 20-1 are shown by circled numbers 1 and 2. A method 2090 can be executed by an ambient device as described herein and equivalents.

A method 1090 can include storing and/or establishing a device ID (A_ID) and a secret value (P) 2090-0. In some embodiments, either or both such values can be established by a manufacturer. Alternatively, either or both values can be established by a secure communication between an ambient device and another device (e.g., storing such values in a highly secure access to protected locations of a nonvolatile memory or the like). Optionally, a method 2090 can receive and store ambient energy 2090-1. However, it is understood that other embodiments do not need stored ambient energy for operations. A method 2090 can determine when an unencrypted frame with a broadcast address is received 2090-2. If such a frame is not received (No from 2090-2), a method can perform other operations (e.g., process other frames and/or other device operations, e.g., update UL data) 2090-3.

Upon receiving an unencrypted frame with a broadcast address (Yes from 2090-2), a method 2090 can determine a source address, first random number (R1) and hash value (hash_rx) from such a frame 2090-4. Optionally, actions 2090-4 can further include determining SAE parameters (S1, E1) for a reader from such a data frame. While UL data may already be present prior to receiving a broadcast frame, optionally, UL data can be generated using ambient energy 2090-5 in response to receiving a broadcast frame.

A method 2090 can compute a hash value using its own device value (A_ID) and a random number (R1) received with the unencrypted frame using ambient power 2090-6. If such a computed hash value does not match a received hash value (No from 2090-7), the unencrypted frame can be ignored 2090-8. If a computed hash value matches a received hash value (Yes from 2090-7), a second random number (R2) and a random MAC address (Aa) can generated using ambient power 2090-8.

A method 2090 can generate an encryption key (K) using shared secret (P) and ambient power 2090-9. Such an action can take any form suitable to the encryption scheme commonly used by an ambient device and corresponding reader. This can include, but is not limited to, deriving a key with a hashing operation 2090-00 or using finite or elliptical curve cryptography 2090-01, as described herein or equivalents. UL data, and any other suitable data, can be encrypted and a corresponding authentication code (auth_code) generated using ambient power 2090-10.

A response frame corresponding to the received broadcast frame can be transmitted using ambient power 2090-12. In some embodiments, such a response frame can include a source address (Aa) corresponding to the random address, a destination address (Ar) corresponding to the source address of the broadcast frame, and a payload that can include first and second random numbers (R1, R2) and encrypted data that can include DL data, the encryption key K, and a sum R1+R2 (which can be used as a nonce). The frame can also include the authentication code generated by the encryption process.

In some embodiments, a method 2090 can be expected to execute single response actions (e.g., generate a response frame). For such single response operations 2090-13 a method 2090 can return to determining if a unencrypted broadcast frame is received 2090-2, or optionally, receiving and storing ambient energy 2090-1.

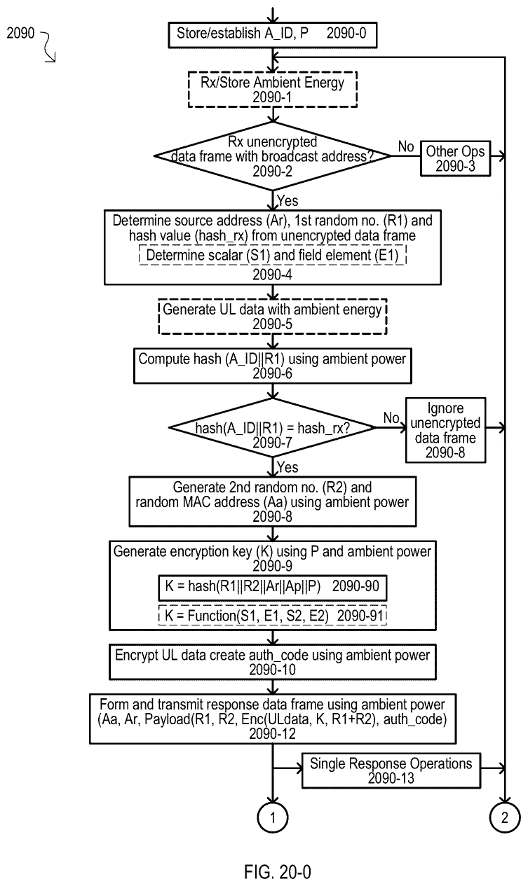

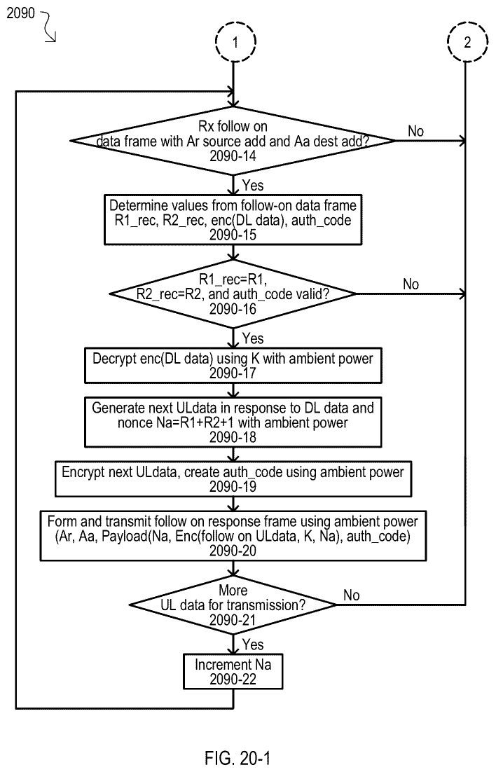

In some embodiments, due to a type of exchange with a reader, a method 2090 can execute more than one exchange. An example of such embodiments is shown in FIG. 20-1.

Referring to FIG. 20-1, a method 2090 can determine if a follow-on frame is received having the same source address as the broad cast frame (Ar) and a destination address previously generated (e.g., 2090-8) 2090-14. It is understood that such a frame, unlike the broadcast frame, can be a unicast frame that includes encrypted data. Upon receiving a follow-on frame a method 2090 can determine a received first random number (R1_rec), received second random number (R2_rec), encrypted DL data (enc(DL_data) and a corresponding authentication code 2090-15.

A method 2090 can determine if received first and second random numbers (R1_rec, R2_rec) match previously determined first and second random numbers (R1, R2) and then validate a received authentication code 2090-16. In some embodiments, validation of an authentication code can be accomplished using the received follow-on frame and encryption key K. However, any other suitable authentication method can be used. If received random numbers match know random numbers, and the following message is authenticated (Yes from 2090-16), encrypted DL data can be decrypted using K and ambient power 2090-17.

A next set of UL data can be generated in response to received DL data and nonce Na can be determined using ambient power 2090-18. In some embodiments, a nonce can be generated with the addition R1+R2+1, however a nonce can be any suitable number that could be understood by a corresponding (e.g., reader) device issuing the follow-on frame. A next set of UL data and any other suitable data can be encrypted using encryption key K and an authentication code generated using ambient power 2090-19. In some embodiments, an operation that encrypts DL data can generate the authentication code (i.e., AEAD).

A method 2090 can form and transmit a follow-on response frame using ambient power 2090-20. In some embodiments, such a follow-on response frame can include Ar, Aa, a payload that includes Na, and encrypted data including follow-on UL data, K and Na), as well as the corresponding authentication code.

A method 2090 can determine if there will be additional UL data for transmission 2090-21. Such an action can be in response to any suitable data, including but not limited to data included in a broadcast frame, follow-on frame, a predetermined state of a reader device executing the method 2090, or combinations thereof. If there will be additional UL data (Yes from 2090-21), nonce Na can be incremented 2090-22. Such an action can take any suitable form, provided it can be understood by a device receiving a further follow-on response frame. A method 2090 can then return to determining if a follow on frame is received (e.g., go to 2090-14).

It is understood that ambient power referred to the method of FIGS. 20-0 and 20-1 can include ambient present in the environment at the time the action is executed, ambient power previously stored or combinations thereof.

In this way, a method can validate an unencrypted broadcast frame using its own ID value, and a random value received with the broadcast frame. UL data can then be encrypted using a secret value that generates an authentication code. The encrypted UL data and authentication code can be transmitted to the source of the broadcast frame.

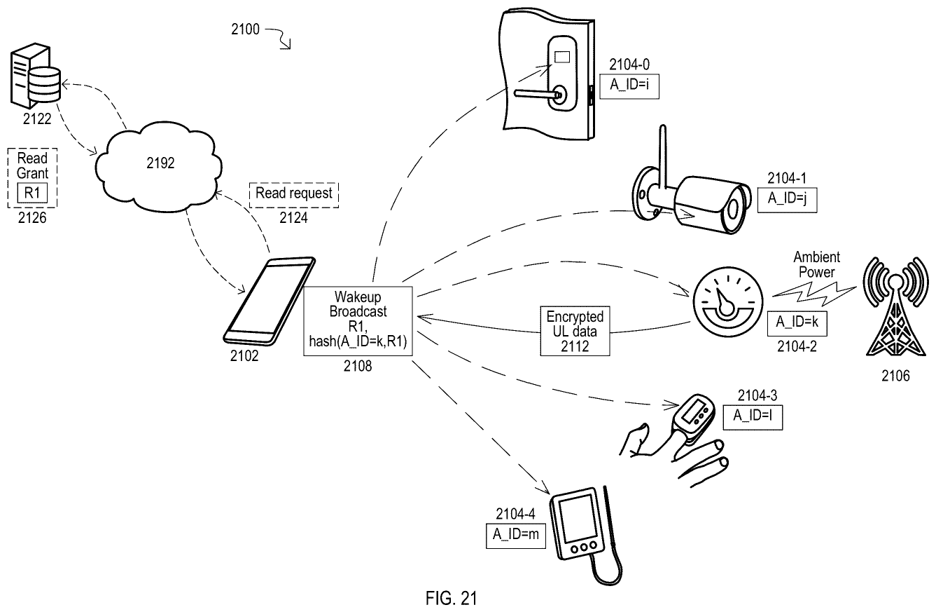

FIG. 21 shows a system 2100 according to a further embodiment. A system 2100 can include a reader 2102 and a number of ambient devices 2104-0 to 2104-5. A reader 2102 can share a different secret value with each ambient device (2104-0 to-5). Each ambient device (2104-0 to -5) can have its own unique device ID, show as A_ID=i to A_ID=I. Optionally, a system 2100 can include a server 2122 that can communicate with a reader 2102 over a network 2192.

Reader 2102 can broadcast a wakeup message 2108 that can include a random number R1, and hash value generated with a target device ID (A_ID=k) and R1. Ambient devices (2104-0 to -5) can receive wakeup message 2108, and using their own A_ID and the received R1 value, determine if it is the target of the wakeup message 2108. In the example shown, ambient devices 2104-0, 2104-1, 2104-3 and 2104-4 do not have a matching A_ID value, and so determine that they are not a target of the wakeup message 2108, and so ignore the wakeup message.

In contrast, ambient device 2104-2 determines that it is the target of the wakeup message 2108, and so, using ambient RF energy from ambient energy source 2106, encrypts UL data and transmits it to reader 2102 in a response frame 2112 using ambient energy. As noted for embodiments herein, ambient energy can be that present in the environment, that is stored by an ambient device, or a combination thereof. As also noted herein, such an action by ambient device 2104-2 can include but two hashing operations and one encryption operation.

Optionally, before transmitting wakeup message 2108, a reader 2108 can transmit a read request message 2124, via network 2192, to server 2122. Server 2122 can return a read grant message 2126 that includes the value R1.

In the embodiment shown, ambient devices (2104-0 to 2104-5) can be “Internet-of-things” (IoT) type devices, including but not limited to: security devices 2104-0/1, instrumentation devices 2104-2, and medical devices 2104-3/4. However, such ambient devices are provided by way of example, and any other suitable ambient device can execute communications transactions as described herein and equivalents.

In this way, various ambient devices in range of a reader device can confirm that they are the targets of a broadcast message, and in response, encrypt and transmit UL data to the reader using ambient energy.

Embodiments can include methods, devices and systems that include, by operation of an ambient wireless device, wirelessly receiving an unencrypted wakeup data frame having a broadcast or multi-cast destination address. A first random address, R1 and a received hashing function result (hash value) can be determined from the wakeup data frame. Using ambient energy, a validation hashing operation can be executed using at least a previously stored first device ID and R1 to generate a local hash value. In response to the local hash value matching the received hash value, generating Aa and R2, deriving an encryption key using at least a previously stored secret value (P). Using ambient energy, encrypting at least UL data generated in response to the wakeup data frame using at least a portion of the encryption key. Wirelessly transmitting a response data frame that includes Aa as a source address, R1, R2, and the encrypted at least UL data. The ambient energy can be derived from RF signals present in an operating environment.

Embodiments can include methods, devices and systems with an ambient wireless that includes memory circuits configured to store P and a device ID and controller circuits configured to receive power from at least one RF ambient energy source. In response to receiving an unencrypted wakeup data frame having a broadcast-type address and a payload that includes at least a source address (Ar) and a first random value (R1), controller circuits can, using ambient energy, validate the wakeup data frame by executing a predetermined operation with at least the device ID and R1, generate Aa, generate K using at least P and R1, using ambient energy, encrypt at least UL data with K, generate a response data frame having Aa as a source address, Ar as a destination address, and a payload that includes at least the encrypted UL data. Wireless circuits can be configured to receive at least the wakeup data frame and transmit at least the response data frame. Ambient energy can be derived from RF signals present in an operating environment.

Embodiments can include methods, devices and systems that include an ambient device having controller circuits configured to store P and a device ID. In response to receiving an unencrypted wakeup data frame having a broadcast-type address and a payload that includes Ar and R1, using ambient energy, validate the wakeup data frame by executing a hashing operation using at least the device ID and R1, generate R2, generate K using at least P, encrypt at least UL data with K, and transmit a response data frame with a the source address of Ar having a payload that includes at least R1, R2 and the encrypted at least UL data. A RF harvester circuit can be configured to generate the ambient energy from RF energy present in the environment. An antenna system can be configured to receive at least the wakeup data frame and transmit at least the response data frame.

Methods, devices and systems according to embodiments can include ambient energy not originating from a source of a wakeup data frame.

Methods, devices and systems according to embodiments can include deriving K by executing a key generation hashing operation that uses at least R1, R2, Ar, Aa, and P.

Methods, devices and systems according to embodiments can include, in response to receiving the wakeup frame, extracting S1 and E1 from the wakeup data frame. In response to the local hash value matching the received hash value, using ambient energy to derive S2 and E2 with at least a previously determined domain parameter set and P. Deriving the encryption key using at least S1, E1, S2 and E2.

Methods, devices and systems according to embodiments can include encrypting at least the UL data by encrypting at least the UL data, K, R1 and R2.

Methods, devices and systems according to embodiments can include the operation of encrypting at least the UL data generating a corresponding authentication code. A response data frame can include the authentication code corresponding to the encrypted UL data.

Methods, devices and systems according to embodiments can include a wakeup data frame payload including. An ambient device can store R1 and R2, and after transmitting a response data frame, receiving a follow-on data frame having Ar as a source address and Aa as a destination address. In response to the stored R1 and R2 matching corresponding received R1 and received R2 values included in the follow-on data frame, decrypting a portion of the follow-on data frame with K to determine DL data, generating and encrypting at least follow-on UL data in response to the decrypted DL data, and generating a nonce value with at least the stored R1, stored R2, and an integer. A follow-on response data frame can be transmitted that includes at least Ar as a destination address, Aa as a source address, the nonce value, and the encrypted at least follow-on UL data.

Methods, devices and systems according to embodiments can include, by operation of a reader device, after transmitting the wakeup data frame and receiving the response data frame, in response to determining that R1 of the response data frame matches that of the wakeup data frame and that R2 has not been previously received by the reader device, deriving the encryption key using at least the secret value, and decrypting at least a portion of the response data frame to produce unencrypted UL data.

Methods, devices and systems according to embodiments can include, by operation of a reader device, prior to transmitting the wakeup data frame, wirelessly transmitting a read request to a server system, and in response to wirelessly receiving a read grant from the server system, that includes at least R1, wirelessly transmitting the wakeup data frame.

Methods, devices and systems according to embodiments can include, an ambient device execute a hashing operation that uses a device ID, R1 and P.

Methods, devices and systems according to embodiments can include ambient device controller circuits configured to, in response to receiving a wakeup data frame, generate a second random number (R2), and generate K using at least P, R1, R2, Aa and Ar.

Methods, devices and systems according to embodiments can include ambient device controller circuits that are configured to, in response to a wakeup frame including S1 and S2, generate S2 and E2 based on a predetermined finite or elliptic curve cryptographic function using at least P. Encryption key K can be generated K using at least S1, E1, S2 and E2.

Methods, devices and systems according to embodiments can include ambient device controller circuits that are configured to, in response to receiving the wakeup data frame, generating an authentication code corresponding to at least the encrypted UL data. A response data frame can include the authentication code.

Methods, devices and systems according to embodiments can include ambient device controller circuits that are configured to generate impedance control signals corresponding to the response data frame. Wireless circuits can be configured to alter an antenna impedance in response to the impedance control signals to transmit a response frame using ambient energy.

Methods, devices and systems according to embodiments can include an ambient power store coupled to receive and store ambient power from an RF harvester circuit.

Methods, devices and systems according to embodiments can include, a reader device that having reader circuits configured to store at least P and the device ID, and, in response to receiving a response data frame, determine whether R1 received in the response data frame matches R1 transmitted in the wakeup data frame, determine if R2 has been received in a previous response data frame, generate K using at least P, and decrypt at least the UL data with K. A reader antenna system can be configured to receive at least the response data frame and transmit at least the wakeup data frame.

Methods, devices and systems according to embodiments can include reader device reader circuits that are configured to, in response determining more messaging is to occur, generate Nr, encrypt at least DL data with K and generate a corresponding authentication code, generate a follow-on data frame that includes at least R1, R2, Nr, the encoded at least DL data, and the corresponding authentication code. A reader antenna system can be configured to transmit the follow-on data frame. Ambient device controller circuits can be further configured to, in response to R1 received in a follow-on data frame matching the R1 received in the wakeup data frame, the R2 received in the follow-on data frame matching that previously generated, and the authentication code authenticating the encoded at least DL data, decrypt the encrypted at least DL data with K, generate Na, generate follow-on UL data corresponding to the DL data, and, using ambient energy, generate and transmit a follow-on response frame that includes Na, the encrypted follow UL data, and an authentication code corresponding to the follow-on UL data.

Methods, devices and systems according to embodiments can include reader device reader circuits configured to, prior to transmitting the wakeup message, transmit a read request to a server system over a network, and receive a read response from the server system over the network that includes at least R1.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of an ambient wireless device,
in response to wirelessly receiving an unencrypted wakeup data frame having a broadcast or multi-cast destination address,
determine a first address, first random value (R1) and a received hashing function result (hash value) from the wakeup data frame,
using ambient energy, executing a validation hashing operation using a previously stored first device identification value (ID) and R1 to generate a local hash value,
in response to the local hash value matching the received hash value,
generating an address (Aa) and a second random value (R2),
deriving an encryption key using at least a previously stored secret value (P),
using ambient energy, encrypting at least uplink (UL) data generated in response to the wakeup data frame using at least a portion of the encryption key, and
wirelessly transmitting a response data frame that includes at least the address (Aa) as a source address, R1, R2, and the encrypted at least UL data; wherein
the ambient energy is harvested from an operating environment of the ambient wireless device.

2. The method of claim 1, wherein the address (Aa) is randomly generated.

3. The method of claim 1, wherein deriving the encryption key includes executing a key generation hashing operation that uses at least R1, R2, a source address of the wakeup frame, Aa, and P.

4. The method of claim 1, further including:
in response to receiving the wakeup frame, extracting a first parameter scalar value (S1) and a first parameter field element value (E1) from the wakeup data frame,
in response to the local hash value matching the received hash value,
using the ambient energy deriving a second scalar value (S2) and second field element value (E2) with at least a previously determined domain parameter set and P, and
deriving the encryption key using at least S1, E1, S2 and E2.

5. The method of claim 1, wherein encrypting at least the UL data includes encrypting at least the UL data, the encryption key, R1 and R2.

6. The method of claim 1, wherein:
encrypting at least the UL data includes generating an authentication code corresponding to at least the encrypted UL data; and
the response data frame further includes the authentication code corresponding to the encrypted UL data.

7. The method of claim 1, further including:
storing R1 and R2,
after transmitting the response data frame, receiving a follow-on data frame having Ar as a source address and Aa as a destination address,
in response to the stored R1 and R2 matching corresponding received R1 and received R2 values included in the follow-on data frame,
decrypting a portion of the follow-on data frame with the encryption key to determine decrypted downlink (DL) data,
generating and encrypting at least follow-on UL data in response to the decrypted DL data,
generating a nonce value with at least the stored R1, stored R2, and an integer,
transmitting a follow-on response data frame that includes at least Ar as a destination address, Aa as a source address, the nonce value, and the encrypted at least follow-on UL data.

8. The method of claim 1, further including:
by operation of a reader device,
after transmitting the wakeup data frame and receiving the response data frame,
in response to determining that R1 of the response data frame matches that of the wakeup data frame and that R2 has not been previously received by the reader device,
deriving the encryption key using at least the secret value, and
decrypting at least a portion of the response data frame to produce unencrypted UL data.

9. The method of claim 8, further including:
prior to transmitting the wakeup data frame,
wirelessly transmitting a read request to a server system, and
in response to wirelessly receiving a read grant from the server system, that includes at least R1, wirelessly transmitting the wakeup data frame.

10. A device, comprising:
memory circuits configured to store at least a secret value (P) and a device identification value (ID);
controller circuits configured to
receive power from at least one radio frequency (RF) ambient energy source, and
in response to receiving an unencrypted wakeup data frame having a broadcast-type address and a payload that includes at least a first random value (R1) and a source address (Ar),
using ambient energy, validate the wakeup data frame by executing a predetermined operation with at least the device ID and R1,
generate an address (Aa),
generate an encryption key (K) using at least P and R1,
using ambient energy, encrypt at least uplink (UL) data with K,
generate a response data frame having Aa as a source address, Ar as a destination address, and a payload that includes at least the encrypted UL data; and
wireless circuits configured to receive at least the wakeup data frame and transmit at least the response data frame; wherein
the ambient energy is harvested from an operating environment of the device.

11. The device of claim 10, wherein the predetermined operation comprises a hashing operation that further uses P.

12. The device of claim 10, wherein:
the controller circuits are further configured to, in response to receiving the wakeup data frame,
generate a second random number (R2), and
generate K using at least P, R1, R2, Aa and Ar.

13. The device of claim 10, wherein:
the controller circuits are further configured to, in response to the wakeup frame further including a first scalar parameter (S1) and a first element parameter (S2),
generate a second scalar parameter (S2) and second element parameter (E2) based on a predetermined finite or elliptic curve cryptographic function using at least P, and
generate K using at least S1, E1, S2 and E2.

14. The device of claim 10, wherein:
the controller circuits are further configured to, in response to receiving the wakeup data frame, generate an authentication code corresponding to at least the encrypted UL data; and
the response data frame includes the authentication code.

15. The device of claim 10, wherein:
the controller circuits are further configured to generate impedance control signals corresponding to the response data frame; and
the wireless circuits are configured to alter an antenna impedance in response to the impedance control signals to transmit the response frame using the ambient energy.

16. A system, comprising:
an ambient device that includes
controller circuits configured to
store at least a secret value (P) and a device identification value (ID), and
in response to receiving an unencrypted wakeup data frame having a broadcast-type address and a payload that includes at least a first random number (R1) and source address (Ar),
using ambient energy,
validate the wakeup data frame by executing a hashing operation using at least the device ID and R1,
generate a second random number (R2),
generate an encryption key (K) using at least P,
encrypt at least uplink (UL) data with K, and
transmit a response data frame with a source address of Ar having a payload that includes at least R1, R2 and the encrypted at least UL data;
a harvester circuit configured to harvest power for the ambient device from energy present in an environment of the ambient device; and
an antenna system configured to receive at least the wakeup data frame and transmit at least the response data frame.

17. The system of claim 16, further including an ambient power store coupled to receive and store ambient power from the harvester circuit.

18. The system of claim 16, further including:
a reader device that includes
reader circuits configured to
store at least P and the device ID,
in response to receiving the response data frame
determine whether R1 received in the response data frame matches R1 transmitted in the wakeup data frame,
determine if R2 has been received in a previous response data frame,
generate K using at least P, and
decrypt at least the UL data with K; and
a reader antenna system configured to receive at least the response data frame and transmit at least the wakeup data frame.

19. The system of claim 18, wherein:
the reader device reader circuits are further configured to, in response to determining more messaging is to occur,
generate a first nonce value (Nr),
encrypt at least downlink (DL) data with K and generate a corresponding authentication code,
generate a follow-on data frame that includes at least R1, R2, Nr, the encoded at least DL data, and the corresponding authentication code, and
the reader antenna system is further configured to transmit the follow-on data frame; and
the ambient device controller circuits are further configured to, in response to R1 received in the follow-on data frame matching the R1 received in the wakeup data frame, R2 received in the follow-on data frame matching that previously generated, and the authentication code authenticating the encoded at least DL data,
decrypt the encrypted at least DL data with K,
generate a second nonce value (Na),
generate follow-on UL data corresponding to the DL data,
using ambient energy harvested by the harvester circuit, generate and transmit a follow-on response frame that includes Na, the encrypted follow UL data, and an authentication code corresponding to the follow-on UL data.

20. The system of claim 16, wherein:
the reader device reader circuits are further configured to, prior to transmitting the wakeup message,
transmit a read request to a server system over a network, and
receive a read response from the server system over the network that includes at least R1.
